(19) United States
(12) Patent Application Publication
(10) Pub. No.: US 2025/0125395 A1
(43) Pub. Date: Apr. 17, 2025

(54) METAL FLUORIDE-FUNCTIONALIZED PROTON EXCHANGE SOLID SUPPORTS, MEMBRANES, AND IONOMERS

(71) Applicant: 1s1 Energy, Inc., Portola Valley, CA (US)

(72) Inventors: Sukanta Bhattacharyya, Belmont, CA (US); Daniel Sobek, Portola Valley, CA (US)

(21) Appl. No.: 18/692,501

(22) PCT Filed: Sep. 16, 2022
(86) PCT No.: PCT/US2022/043878

§ 371 Date: Mar. 15, 2024

Related U.S. Application Data
(60) Provisional application No. 63/245,614, filed on Sep. 17, 2021.

(51) Int. Cl. H01M 8/1039; B01J 39/05; B01J 39/19; B01J 39/20; C25B 13/08; H01M 8/10; H01M 8/1025; H01M 8/103; H01M 8/1034

(52) U.S. Cl. CPC H01M 8/1039; B01J 39/05; B01J 39/19; B01J 39/20; C25B 13/08; H01M 8/1025; H01M 8/103; H01M 8/1034; H01M 2008/1095; H01M 2300/0082

(57) ABSTRACT

A metal fluoride-functionalized proton-exchange solid support includes a proton-exchange solid support comprising a substituent group including an oxygen atom, and a metal fluoride group comprising a multivalent metal atom covalently bonded to the oxygen atom included in the substituent group, wherein the metal atom has a negative formal charge.

### RELATED APPLICATIONS

The present application claims priority to U.S. Provisional Patent Application No. 63/245,614, filed Sep. 17, 2021, the contents of which are hereby incorporated by reference in their entirety.

### BACKGROUND INFORMATION

Proton exchange membranes (PEMs) are semi-permeable membranes that are engineered to transport protons (H⁺) while being impermeable to gases such as hydrogen and oxygen. PEMs may be used in electrochemical operations such as water electrolysis, hydrogen fuel cell applications, and electrochemical reduction of carbon dioxide to methanol. However, these application involve strong oxidation and reduction chemistries under ambient to high temperature and acidic conditions. Effective PEM polymer matrices and the molecular functional groups therein responsible for proton transport properties must remain robust under the harsh reaction conditions of redox stress.

PEMs are composed of a mechanically and chemically resistant porous framework with highly acidic functional groups. Conventional PEMs and ionomers used for catalyst layer preparations mostly contain sulfonic acid functional groups as proton transport agents. For example, Nafion-based proton exchange membranes contain a PTFE porous framework with sulfonic acid groups. The easily dissociable sulfonic acid groups serve as proton transport agents in the PEM. However, sulfonic acid functional groups have only limited ability to withstand the redox stress from electrochemical operations, mainly due to the intrinsic physicochemical properties of sulfur.

### SUMMARY

The following description presents a simplified summary of one or more aspects of the methods and systems described herein in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects of the methods and systems described herein in a simplified form as a prelude to the more detailed description that is presented below.

In some illustrative examples, a metal fluoride-functionalized proton-exchange solid support comprises: a proton-exchange solid support comprising a substituent group including an oxygen (O) atom; and a metal fluoride group comprising a multivalent metal atom covalently bonded to the oxygen atom included in the substituent group; wherein the metal atom has a negative formal charge.

In some illustrative examples, a metal fluoride-functionalized proton-exchange solid support has general formula (Ia) or (Ib):

[SS]—Xₘ-MFₙ (Ia)

[SS]—R_{q}—Xₘ-MFₙ (Ib)

wherein: [SS] represents a solid support; each X independently represents a substituent group having any one of formula (IIa), (IIb), (IIc), (IId), (IIe), (IIf), or (IIg):

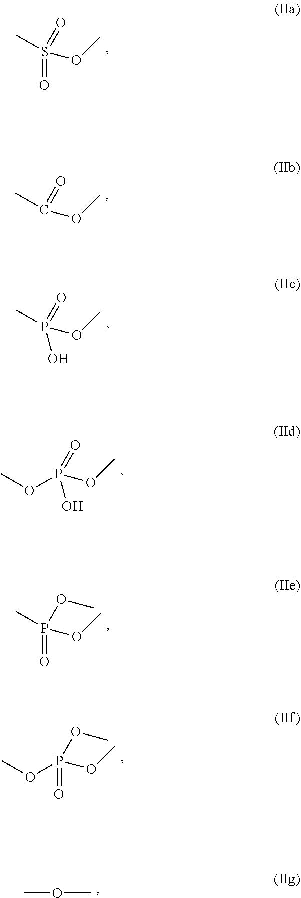

m is one (1), two (2), or three (3); M is a multivalent metal atom covalently bonded to one or more oxygen (O) atoms in one or more substituent groups X and has a negative formal charge; n is three (3) or four (4); the sum of m and n is four (4), five (5), or six (6); each R independently represents a C₁ to C₃₀ alkyl linker chain that links a substituent group X with solid support [SS] and optionally has one or more pendant moieties, which may be the same or different for each atom in the linker chain R and which may comprise hydrogen, a hydroxyl group, a fluoro group, a chloro group, a dialkylamino group, a cyano group, a carboxylic acid group, a carboxylic amide group, a carboxylic ester group, an alkyl group, an alkoxy group, and an aryl group; and q is an integer equal to or less than m.

In some illustrative examples, a method of making a metal fluoride-functionalized proton-exchange solid support comprises: covalently bonding a multivalent metal (M) atom of a metal fluoride having general formula MFₙ with an oxygen atom of a proton-exchange solid support, wherein n is three or four; and wherein the metal (M) atom covalently bonded with the oxygen atom has a negative formal charge.

In some illustrative examples, a membrane electrode assembly comprises: a cathode; an anode; and a proton exchange membrane positioned between the cathode and the anode, the proton exchange membrane comprising a metal fluoride-functionalized proton-exchange solid support comprising: a proton-exchange solid support comprising a substituent group including an oxygen (O) atom; and a metal fluoride group comprising a multivalent metal atom covalently bonded to the oxygen atom included in the substituent group; wherein the metal atom has a negative formal charge.

In some illustrative examples, a solid electrolyte comprises: a proton-exchange solid support comprising an oxygen atom; and a metal fluoride group comprising a metal atom covalently bonded to the oxygen atom and forming a tetravalent, pentavalent, or hexavalent structure; wherein the metal atom has a formal negative charge.

In some illustrative examples, a proton-exchange membrane comprises: a porous polymer network; and a metal fluoride cross-linked acid dopant.

### BRIEF DESCRIPTION OF THE DRAWINGS

The concepts described herein will be described by way of example only, with reference to the drawings. The drawings illustrate various embodiments and are a part of the specification. The illustrated embodiments are merely examples and do not limit the scope of the disclosure. Throughout the drawings, identical or similar reference numbers designate identical or similar elements.

FIG. 1A shows an illustrative configuration of a portion of a porous structural framework that implements a proton-exchange solid support.

FIG. 1B shows an illustrative configuration of a solid support particle that may implement a proton-exchange solid support.

FIGS. 2A to 6B show various illustrative reaction schemes for synthesizing a metal fluoride-functionalized proton-exchange solid support using a metal tetrafluoride (MF₄).

FIGS. 7A to 12B show various illustrative reaction schemes for synthesizing a metal fluoride-functionalized proton-exchange solid support using a metal trifluoride (MF₃).

FIG. 13 shows another illustrative reaction scheme for synthesizing a metal fluoride-functionalized proton-exchange solid support according to a deprotonation-coupling-protonation process.

FIG. 14A shows an illustrative unfunctionalized perfluorinated polymer that may be used as a proton-exchange membrane or ionomer.

FIG. 14B shows an illustrative metal fluoride cross-linked acid dopant network.

FIG. 15 shows an illustrative proton exchange membrane including metal fluoride groups bonded to pore surfaces.

FIG. 16 shows an illustrative proton exchange membrane water electrolysis system incorporating a metal fluoride-functionalized porous membrane.

FIG. 17 shows an illustrative proton exchange membrane fuel cell incorporating a metal fluoride-functionalized porous membrane.

### DETAILED DESCRIPTION

Herein described are metal fluoride-functionalized proton-exchange solid-supports, methods of making and using metal fluoride-functionalized proton-exchange solid-supports, and apparatuses including metal fluoride-functionalized proton-exchange solid-supports. In some examples, a metal fluoride-functionalized proton-exchange solid-support comprises a proton-exchange solid support comprising a substituent group including an oxygen (O) atom, and a metal fluoride group comprising a multivalent metal (M) atom covalently bonded to the oxygen atom and covalently bonded to three (3) or four (4) fluorine (F) atoms. The multivalent metal atom in the metal fluoride group is a transition metal, a metal, or a metalloid and may be selected from elements included in Group 4 (e.g., zirconium (Zr)), Group 13 (e.g., boron (B), aluminum (Al), gallium (Ga), and indium (In)), and Group 14 (e.g., silicon (Si), germanium (Ge), and tin (Sn)). As used herein, “multivalent” means that a species is not restricted to a specific number of valence bonds, but may have multiple different valence states each with a different number of valence bonds. Thus, the multivalent metal atom may “expand its valence state,” such as by one to three to form a tetravalent, pentavalent, or hexavalent structure with a negative one (−1), negative two (−2), or negative three (−3) formal charge. For example, boron has three valence electrons and has a ground state electron configuration of 1s²2s²2p¹. Boron generally forms trivalent neutral compounds in which boron has three covalent bonds. Thus, the boron atom is sp² hybridized with an empty p-orbital, which makes trivalent boron compounds electron-deficient. However, boron is multivalent due to the empty p-orbital, so boron can also form negatively charged tetravalent compounds with four covalent bonds.

When metal fluorides (e.g., MF₃ or MF₄) combine with a proton dissociative group of a proton-exchange solid-support, the metal atom expands its valence to form a covalent bond with an oxygen atom of the proton dissociative group. Thus, the metal atom gains a formal negative charge, which is balanced by an appropriate number of protons, thus making the metal fluoride group intrinsically ionic and acidic. As a result, cation exchange occurs at the metal atom having a negative formal charge. In PEMs that include metal fluoride-functionalized proton-exchange solid supports, cation (e.g., proton) exchange is provided by protons ionically linked to the tetravalent, pentavalent, or hexavalent metal fluoride structures having a formal negative charge. As a result, the ionic metal fluoride groups require little to no activation time.

The metal fluoride-functionalized proton-exchange solid supports described herein may be used under the harsh conditions of electrochemical devices, such as PEMs for water electrolysis, fuel cell devices (e.g., hydrogen fuel cell devices), and electrochemical reduction of carbon dioxide to methanol. Typically, anions from conventional pendant acid groups, such as sulfonic acid, phosphoric acid, polyphosphoric acid, and carboxylic acid, are coordinating anions and therefore participate in secondary destructive oxidative mechanisms that compromise their performance in electrochemical devices. In contrast, the negatively-charged metal fluoride groups of the metal fluoride-functionalized proton-exchange solid supports are non-coordinating, so that the metal fluoride groups do not form any dative bond with electron acceptors. Moreover, the elements in these metal fluoride groups cannot further accept electrons due to their uniquely saturated electronic configurations. Thus, the metal fluoride groups remain inert under reducing conditions. As a result, the metal fluoride-functionalized proton-exchange solid supports are mechanically robust and stable. Furthermore, since fluoride is not a leaving group, the metal fluoride-functionalized proton-exchange solid supports described herein will withstand chlorine contamination.

The metal fluorides used as acidic groups in the metal fluoride-functionalized proton-exchange solid supports offer flexible chemical design to fine tune hydrophobic and hydrophilic balance of PEMs and ionomers without altering their ion exchange capacity or equivalent weight. Due to the above characteristics, the PEMS and ionomers described herein offer operating advantages at higher temperatures as compared with conventional PEMs and ionomers.

Functionalizing perfluorinated proton-exchange solid supports with metal fluorides also has the unique advantage of minimizing distortion of the proton-exchange solid supports. Generally, functionalizing a polymer proton-exchange solid support with a species that is chemically different from the polymer will cause distortion. However, a perfluorinated proton-exchange solid support, such as Nafion, may be functionalized with a metal fluoride little to no distortion.

For the above reasons, metal fluoride-functionalized proton-exchange solid supports described herein have high mechanical strength, high proton conductivity, low electron conductivity, chemical stability under a large pH gradient, durability, and low cost of production. Implementations and uses of metal fluoride-functionalized proton-exchange solid supports in PEMs will be described herein in more detail.

The metal fluoride groups also offer new polymer designs to chemically link different polymer matrices through cross-linking, increasing the choices of PEM for better mechanical durability and functional properties. For example, hybrids of PTFE/non-PTFE or PTFE/ceramics or non-PTFE PEMS are possible using metal fluoride-functionalized proton-exchange solid supports.

The compositions, apparatuses, and methods described herein may provide one or more of the benefits mentioned above and/or various additional and/or alternative benefits that will be made apparent herein. Various embodiments will now be described in more detail with reference to the figures. It will be understood that the following embodiments are merely illustrative and are not limiting, as various modifications may be made within the scope of the present disclosure.

In some examples, an illustrative metal fluoride-functionalized proton-exchange solid support may have the general formula (Ia):

[SS]—Xₘ-MFₙ (Ia)

wherein [SS] represents a solid support; each X is a substituent group including: (i) an oxygen (O) atom, or (ii) a sulfur (S) atom, a carbon (C) atom, or a phosphorous (P) atom covalently bonded to one or more oxygen (O) atoms; MFₙ is a metal fluoride group including a multivalent metal (M) atom covalently bonded to one or more of the oxygen atoms of one or more substituent groups X; m is one (1), two (2), or three (3); n is three (3) or four (4); and the sum of n and m is four (4), five (5), or six (6) so that metal (M) atom forms a tetravalent, pentavalent, or hexavalent structure. As will be explained herein in more detail, each substituent group X may be derived from a precursor proton-dissociative substituent group, such as a hydroxyl group, an acid group (e.g., an oxoacid such as a carboxylic acid group, a sulfonic acid group (e.g., a sulfo group), a phosphonic acid group, or a phosphate group), or an alcohol (e.g., a phenol group).

In additional or alternative examples, an illustrative metal fluoride-functionalized proton-exchange solid support may include one or more linker chains that link one or more substituent groups X with solid support [SS]. For example, a metal fluoride-functionalized proton-exchange solid support may have the general formula (Ib):

[SS]—R_{q}—Xₘ-MFₙ (Ib)

wherein [SS], X, M, m, and n are as described above and each R represents a C₁ to C₃₀ alkyl linker chain that links a substituent group X with solid support [SS] and optionally has one or more pendant moieties, which may be the same or different for each atom in the linker chain R and which may comprise hydrogen, a hydroxyl group, a fluoro group, a chloro group, a dialkylamino group, a cyano group, a carboxylic acid group, a carboxylic amide group, a carboxylic ester group, an alkyl group, an alkoxy group, and an aryl group; and q is an integer equal to or less than m so that one or more substituent groups X may be linked to solid support [SS] by a linker chain R.

In some examples, solid support [SS], substituent group X, and optionally linker chain R, in combination, may be derived from a precursor proton-exchange solid support. For example, as will be explained herein in more detail, the proton-exchange solid support ([SS]—X or [SS]—R—X), prior to modification with a metal fluoride (MFₙ), may be a commercially-available polymer (e.g., a sulfonic acid-functionalized PTFE) and may itself serve as a proton transport agent by dissociation of a precursor of substituent group X (e.g., a proton-dissociative substituent group such as a carboxylic acid group, a sulfonic acid group, a phosphonic acid group, a phosphate group, an alcohol group (e.g., a phenol group), or a hydroxyl group).

Solid support [SS] may be formed of any suitable material or combination of materials, including inorganic materials and/or organic materials. Suitable inorganic materials may include amorphous inorganic materials (e.g., glass, fused silica, or ceramics) and/or crystalline inorganic materials (e.g., quartz, single crystal silicon, or alumina). Suitable organic materials may include, for example, synthetic polymers, natural polymers (e.g., lignin, cellulose, chitin, etc.), ionomers, and the like. In some examples, substituent group X is linked to a side chain of solid support [SS] or comprises a side chain of solid support [SS].

Various general examples of the metal fluoride-functionalized proton-exchange solid support of formulas (Ia) and (Ib) will now be described. In some examples where m is one (1), the metal fluoride-functionalized proton-exchange solid support has the following formula (Ia1) or (Ib1):

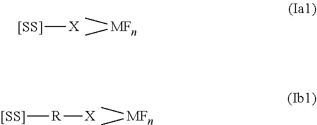

where X, M, and R are as described above and n is three (3) or four (4). In these examples, metal atom M is covalently bonded to two different oxygen (O) atoms in substituent group X.

In some examples where m is two (2), the metal fluoride-functionalized proton-exchange solid support has the following formula (Ia2) or (Ib2):

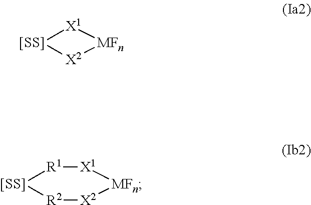

where X¹ and X² each represent substituent group X and may be the same or different; n is three (3) or four (4); R¹ and R² each represent linker chain R and may be the same or different; and the multivalent metal atom M is covalently bonded to an oxygen (O) atom included in each of substituent group X¹ and substituent group X².

In some examples where m is three (3), the metal fluoride-functionalized proton-exchange solid support has the following formula (Ia3) or (Ib3):

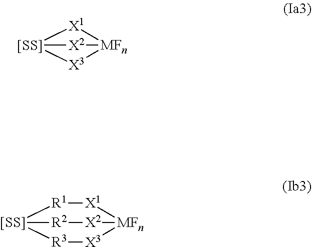

where X¹, X², and X³ each represent substituent group X and may be the same or different; n is three (3); R¹, R², and R³ each represent linker chain R and may be the same or different; and the multivalent metal (M) atom is covalently bonded to an oxygen (O) atom included in each of substituent group X¹, substituent group X², and substituent group X³.

In some examples where m is two (2), the metal fluoride-functionalized proton-exchange solid support has the following formula (Ia4) or (Ib4):

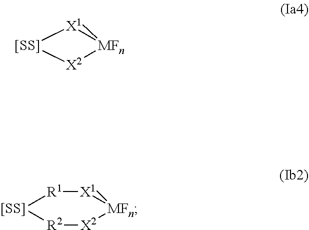

where X¹ represents a substituent group X having two oxygen (O) atoms and X² represents a substituent group X having an oxygen (O) atom and may be the same as or different from X¹; n is three (3); R¹ and R² each represent linker chain R and may be the same or different; and the multivalent metal (M) atom is covalently bonded to the two oxygen atoms (O) included in substituent group X¹ and is covalently bonded to the oxygen (O) atom in substituent group X².

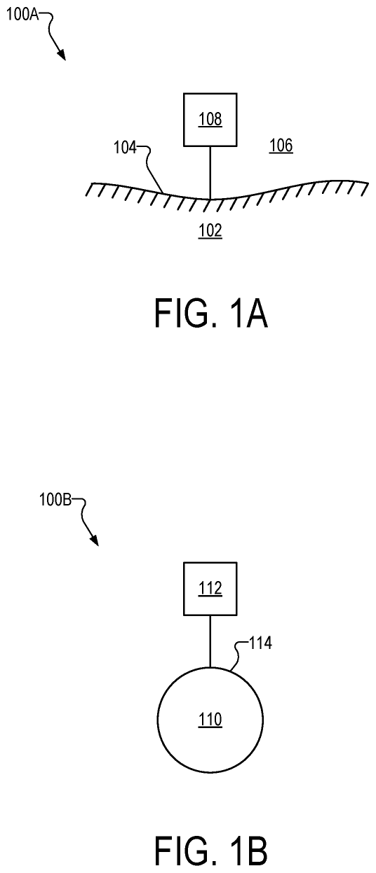

Solid support [SS] and/or the proton-exchange solid support of formulas (Ia) and (Ib) (e.g., [SS]—Xₘ or [SS]—R_{q}—Xₘ) may have any suitable shape and form, such as a porous structural framework or a solid support particle. FIG. 1A shows an illustrative configuration 100A of a portion of a porous structural framework 102. Porous structural framework 102 may implement solid support [SS] or the proton-exchange solid support of formulas (Ia) and (Ib) (e.g., [SS]—Xₘ or [SS]—R_{q}—Xₘ). Porous structural framework 102 includes a porous network having pore surfaces (e.g. pore surface 104) adjacent to pores (e.g., pore 106). The pore surface 104 is functionalized with a metal fluoride group 108 (e.g., MFₙ). While FIG. 1A shows only one metal fluoride group 108 bonded to pore surface 104, porous structural framework 102 may have any other number and concentration of pores 106 and metal fluoride groups 108 bonded to pore surfaces 104. In some examples, porous structural framework 102 is a porous polymer network.

A solid support particle may include, for example, a microparticle, a nanoparticle, and/or a resin bead. FIG. 1B shows an illustrative configuration 100B in which the solid support [SS] or proton-exchange solid support of formulas (Ia) and (Ib) (e.g., [SS]—Xₘ or [SS]—R_{q}—Xₘ) is implemented as a solid support particle 110. A metal fluoride group 112 is bonded to a surface 114 of solid support particle 110. In some examples (not shown), multiple solid support particles 110 may be linked together to form a porous structural framework (e.g., porous structural framework 102) with metal fluoride groups 112 bonded to pore surfaces (e.g., surfaces 114) within the porous structural framework.

Solid support particles 110 may be formed of any suitable material, such as any material described above for porous structural framework 102, such as inorganic molecules (e.g., fused silica particles, ceramic particles, etc.) or natural or synthetic organic molecules (e.g., polymers). Solid support particles 110 may have any suitable shape and size, ranging from tens of nanometers (nm) to hundreds of microns (μm). The porosity of a porous structural framework formed by solid support particles 110 may be controlled and defined by the size and/or shape of solid support particles 110. Solid support particles 110 may also be selected for their mechanical strength, their durability in an environment with a broad range of pH gradient, and/or for their affinity to water (e.g., they may be chosen to be hydrophilic or hydrophobic depending on the desired water-affinity balance).

Referring again to formulas (Ia) and (Ib), each substituent group X contains (i) an oxygen (O) atom, or (ii) a sulfur (S) atom, a carbon (C) atom, or a phosphorous (P) atom covalently bonded to one or more oxygen (O) atoms. In some examples, substituent group X is a derivative of a precursor proton-dissociative substituent group containing a hydroxyl group, such as a pendant hydroxyl group linked to solid support [SS], a pendant acid group linked to solid support [SS](such as a sulfonic acid group, a sulfuric acid group, a carboxylic acid group, a carbonic acid group, a phosphonic acid group, a phosphoric acid group), or an alcohol (e.g., a phenol group) or hydroxyl group linked to solid support [SS]. In some examples, the sulfur (S) atom, carbon (C) atom, or phosphorous (P) atom of substituent group X is also covalently bonded to an additional oxygen (O) atom by a double bond. Examples of substituent group X may include, without limitation, an oxygen atom (O) (derived from a pendant hydroxyl group), a carboxylate ester group (—C(═O)O—), a carbonate ester group (—OC(═O)O—), a sulfonic ester group (—S(═O)₂O—), a sulfate ester group (—OS(═O)₂O—), a phosphoryl group (—P(═O)(OH)O— or —P(═O)(O—)₂), a phosphate group (—OP(═O)(O—)₂), an aryloxy group (OAr) (e.g., a phenoxy group), or an alkoxy group (—OR—). Non-limiting examples of substituent group X are shown in the illustrative reaction schemes described herein.

The metal fluoride groups have the general formula -MFₙ where the multivalent metal (M) atom is a transition metal atom, a metal atom, or a metalloid atom selected from Group 4 (e.g., zirconium (Zr)), Group 13 (e.g., boron (B), aluminum (Al), gallium (Ga), and indium (In)), and Group 14 (e.g., silicon (Si), germanium (Ge), and tin (Sn)) and n is four (4) or five (5). The metal (M) atom is covalently bonded to one or more oxygen (O) atoms of substituent group X. For example, when substituent X is a derivative of a precursor acid group containing a sulfur (S) atom, a carbon (C) atom, or a phosphorous (P) atom, the metal (M) atom is bonded to the oxygen (O) atom that is covalently bonded to the sulfur (S) atom, carbon (C) atom, or phosphorous (P) atom of substituent group X.

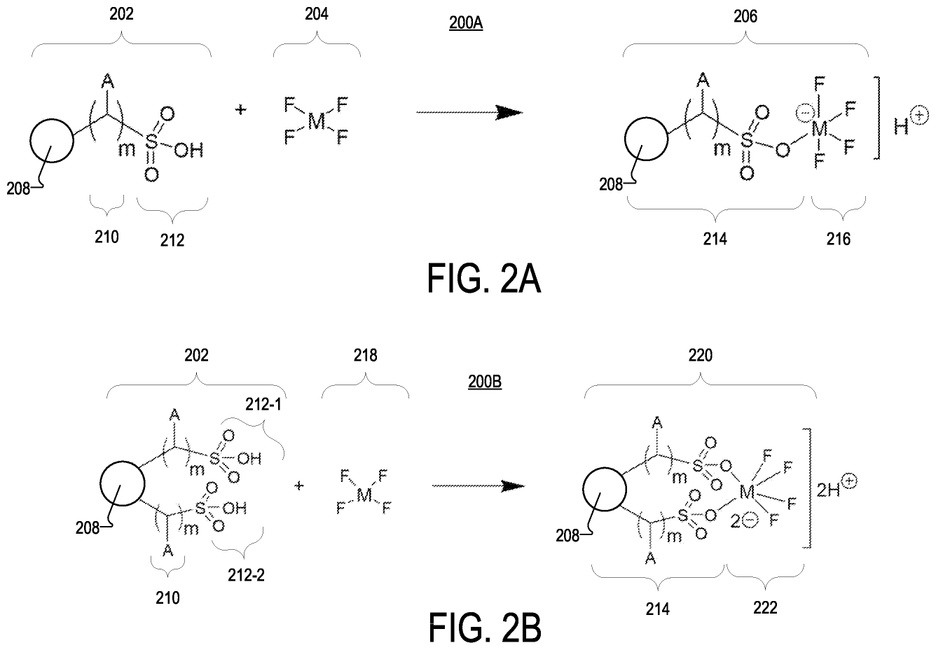

A metal fluoride-functionalized proton-exchange solid support may be synthesized in any suitable way. In some examples, a metal fluoride-functionalized proton-exchange solid support may be synthesized by combining a proton-exchange solid support with metal tetrafluoride (MF₄), as will now be shown and described with reference to FIGS. 2A-6B. The following reaction schemes are merely illustrative and are not limiting.

FIG. 2A shows an illustrative reaction scheme 200A for synthesizing a metal fluoride-functionalized proton-exchange solid support presenting a metal fluoride group linked to a sulfur (S) atom by way of an oxygen (O) atom. As shown, a proton-exchange solid support 202 is modified with a metal tetrafluoride 204 to produce a metal fluoride-containing proton-exchange solid support 206.

Proton-exchange solid support 202 includes a solid support 208, a linker chain 210, and a sulfonic acid group 212. However, linker chain 210 is optional and may be omitted in other examples. As shown, solid support 208 is a solid support particle (e.g., solid support particle 110). However, in other examples solid support 208 may be any other suitable solid support, including a porous structural framework (e.g., porous structural framework 102) or a polymer or polymer backbone.

Proton-exchange solid support 202 may include any inorganic and/or organic material described herein. In some examples, proton-exchange solid support 202 comprises a sulfonic acid-functionalized polymer, such as a polyfluorosulfonic acid polymer, a perfluorinated sulfonic acid polymer, or a sulfonated PTFE based fluoropolymer-copolymer. Examples of proton-exchange solid support 202 may include, without limitation, ethanesulfonyl fluoride, 2-[1-[difluoro-[(trifluoroethenyl)oxy]methyl]-1,2,2,2-tetrafluoroethoxy]-1,1,2,2,-tetrafluoro-, with tetrafluoroethylene and tetrafluoroethylene-perfluoro-3,6-dioxa-4-methyl-7-octenesulfonic acid copolymer. Commercially available sulfonic acid-functionalized polymers include, without limitation, Nafion® (available from E.I. Dupont de Nemours and Company in various configurations and grades, including Nafion-H, Nafion HP Nafion 117, Nafion 115, Nafion 212, Nafion 211, Nafion NE1035, Nafion XL, etc.), Aquivion® (available from Solvay S.A. in different configurations and grades, including Aquivion® E98-05, Aquivion® PW98, Aquivion® PW87S, etc.), Gore-Select® (available from W.L. Gore & Associates, Inc.), Flemion™ (available from Asahi Glass Company), Pemion+™ (available from Ionomr Innovations, Inc.), and any combination, derivative, grade, or configuration thereof.

Linker chain 210 links sulfonic acid group 212 to solid support 208. Linker chain 210 may be implemented by any suitable linker chain, including any linker chain described herein (e.g., linker chain R of formula (Ib)). In some examples, linker chain 210 contains carbon (C), oxygen (O), and/or nitrogen (N). As shown in FIG. 2A, linker chain 210 is an alkyl chain of length m, where m ranges from 1 to 30, and has one or more side groups A, each of which may independently be hydrogen (H), a hydroxyl group (OH), a fluoro group (F), a chloro group (Cl), a dialkylamino group (NR₂, in which R may represent hydrogen or an organic combining group, such as a methyl group (CH₃)), a cyano group (CN), a carboxylic acid (COOH) group, a carboxylic amide group, an ester group, an alkyl group, an alkoxy group, and an aryl group. In some examples, linker chain 210 is a long-side chain (LSC) having at least two ether linkages and four or more polyfluorinated carbon units (e.g., —CF₂— and/or —CF₃). In other examples, linker chain 210 is a short-side chain (SSC) having one ether linkage and two polyfluorinated carbon units. In further examples, linker chain 210 is a mid-side chain (MSC) having one ether linkage and four polyfluorinated carbon units. Other configurations are also contemplated by linker chain 210.

Metal tetrafluoride 204 is a metal fluoride of formula MF₄ comprising a tetravalent metal (M) atom covalently bonded to four fluorine (F) atoms. However, metal (M) atom is multivalent and thus is able to expand its valence to covalently bond with a fifth atom and thereby form a pentavalent structure with a formal negative charge. Metal (M) atom may be any suitable metal described above with reference to general formulas (Ia) and (Ib) and that may expand its valence from four to five and/or six, such as silicon (Si), germanium (Ge), tin (Sn), or zirconium (Zr).

In some examples, metal tetrafluoride 204 and sulfonic acid group 212 are combined in approximately a one-to-one (1:1) stoichiometric ratio, although they may be combined in any other suitable ratio. The proton-exchange solid support 202 and metal tetrafluoride 204 may be combined in the presence of any suitable reaction solvent, such as deionized water and/or water-miscible organic solvents including acetonitrile, dimethylformamide, N-methylpyrrolidone, and/or dimethylacetamide. The resulting metal fluoride-containing proton-exchange solid support 206 includes a proton-exchange solid support 214 comprising a sulfur atom covalently bonded to an oxygen (O) atom, and a metal fluoride group 216 comprising a pentavalent metal (M) atom (M) covalently bonded to the oxygen (O) atom and to four fluorine (F) atoms. As mentioned above, metal (M) atom has four valence electrons but expands its valence to form a pentavalent structure with a negative formal charge by covalently bonding with five atoms, as shown in FIG. 2A. Thus, metal fluoride group 216 is intrinsically ionic and serves as a proton transport agent.

FIG. 2B shows an illustrative reaction scheme 200B for synthesizing a metal fluoride-functionalized proton-exchange solid support presenting a hexavalent metal fluoride group linked to two sulfur (S) atoms through two oxygen (O) atoms. Reaction scheme 200B is similar to reaction scheme 200A except that, in reaction scheme 200B, a single metal tetrafluoride 218 combines with two oxygen (O) atoms (an oxygen (O) atom in each of two different sulfonic acid groups 212-1 and 212-2), thereby expanding the coordination number of the metal (M) atom to six and forming a hexavalent structure. The resulting metal fluoride-containing proton-exchange solid support 220 includes a proton-exchange solid support 214 comprising two sulfur (S) atoms each covalently bonded to an oxygen (O) atom, and a metal fluoride group 222 comprising a hexavalent metal (M) atom covalently bonded to two oxygen (O) atoms and to four fluorine (F) atoms. As can be seen in FIG. 2B, the hexavalent metal fluoride group 222 has a negative two (−2) formal charge. Thus, metal fluoride group 216 is intrinsically ionic and serves as a proton transport agent.

While FIG. 2B shows that metal tetrafluoride 218 combines with two sulfonic acid groups 212 from the same solid support 208 (e.g., a same solid support particle), metal tetrafluoride 218 may alternatively combine with two sulfonic acid groups 212 from different solid supports 208. Moreover, metal tetrafluoride 218 may alternatively combine with two different types of proton-dissociative groups (e.g., acid groups) connected to the same or different solid supports 208, including any of the proton-dissociative groups described herein.

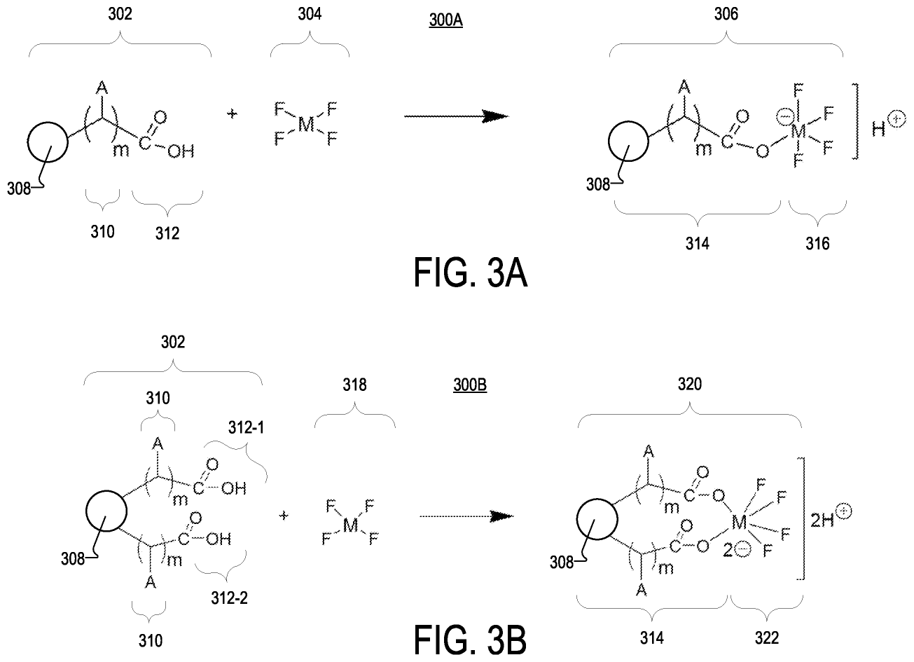

FIG. 3A shows an illustrative reaction scheme 300A for synthesizing a metal fluoride-functionalized proton-exchange solid support presenting a metal fluoride group linked to a carbon (C) atom by way of an oxygen (O) atom. As shown, a proton-exchange solid support 302 is modified with metal tetrafluoride 304 to produce metal fluoride-functionalized proton-exchange solid support 306.

Proton-exchange solid support 302 includes a solid support 308, a linker chain 310, and a carboxylic acid group 312. However, linker chain 310 is optional and may be omitted in other examples. Solid support 308 may be implemented by any solid support described herein (e.g., solid support 208) and may be implemented in any suitable form, including as a porous structural framework (e.g., porous structural framework 102) or a solid support particle (e.g., solid support particle 110). In some examples, proton-exchange solid support 302 comprises a carboxylic acid-functionalized polymer, such as a polyacrylic acid polymer.

Linker chain 310 links carboxylic acid group 312 to solid support 308. Linker chain 310 may be implemented by any suitable linker chain, including any linker chain described herein (e.g., linker chain R of formula (Ib) or linker chain 210).

Metal tetrafluoride 304 comprises a metal fluoride of formula MF₄ comprising a tetravalent metal (M) atom covalently bonded to four fluorine (F) atoms. However, metal (M) atom is multivalent and thus is able to expand its valence to covalently bond with a fifth atom and thereby form a pentavalent structure with a negative formal charge. Metal (M) atom may be any suitable metal described above with reference to general formulas (Ia) and (Ib), such as silicon (Si), germanium (Ge), tin (Sn), or zirconium (Zr).

In some examples, metal tetrafluoride 304 and carboxylic acid group 312 are combined in approximately a one-to-one (1:1) stoichiometric ratio, although they may be combined in any other suitable ratio. The proton-exchange solid support 302 and metal tetrafluoride 304 may be combined in the presence of any suitable reaction solvent, such as deionized water and/or water-miscible organic solvents including acetonitrile, dimethylformamide, N-methylpyrrolidone, and/or dimethylacetamide. The resulting metal fluoride-functionalized proton-exchange solid support 306 includes a proton-exchange solid support 314 comprising a carbon atom covalently bonded to an oxygen atom, and a metal fluoride group 316 comprising a pentavalent metal (M) atom covalently bonded to the oxygen atom and to four fluorine (F) atoms. As can be seen in FIG. 3A, the pentavalent metal fluoride group 316 has a negative formal charge. Thus, metal fluoride group 316 is intrinsically ionic and serves as a proton transport agent.

FIG. 3B shows an illustrative reaction scheme 300B for synthesizing a metal fluoride-functionalized proton-exchange solid support presenting a metal fluoride group linked to two carbon (C) atoms through two oxygen (O) atoms. Reaction scheme 300B is similar to reaction scheme 300A except that, in reaction scheme 300B, a single metal tetrafluoride 318 combines with an oxygen (O) atom in each of two different carboxylic acid groups 312 (e.g., an oxygen (O) atom in each of two different carboxylic acid groups 312-1 and 312-2), thereby expanding the coordination number of the metal (M) atom to six and forming a hexavalent structure. The resulting metal fluoride-containing proton-exchange solid support 320 includes a proton-exchange solid support 314 comprising two carbon (C) atoms each covalently bonded to an oxygen (O) atom, and a metal fluoride group 322 comprising a hexavalent metal (M) atom covalently bonded to both oxygen (O) atoms and to four fluorine (F) atoms. As can be seen in FIG. 3B, the metal fluoride group 322 has a negative two (−2) formal charge. Thus, metal fluoride group 322 is intrinsically ionic and serves as a proton transport agent.

While FIG. 3B shows that metal tetrafluoride 318 combines with two carboxylic acid groups 312 from the same solid support 308, metal tetrafluoride 318 may alternatively combine with two carboxylic acid groups 312 from different solid supports 308. Moreover, metal tetrafluoride 318 may alternatively combine with two different types of proton-dissociative groups connected to the same or different solid supports 308, including any of the proton-dissociative groups described herein.

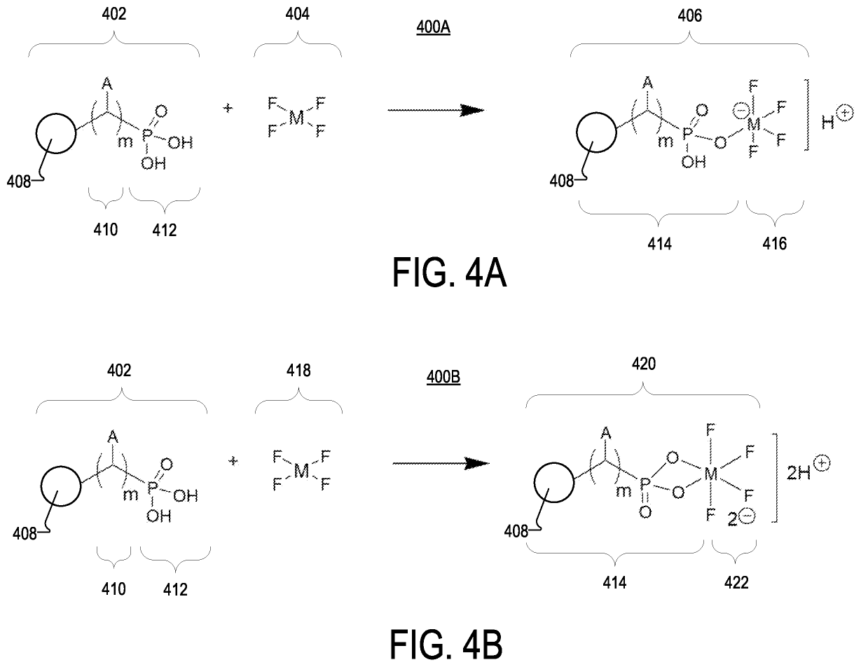

FIG. 4A shows an illustrative reaction scheme 400A for synthesizing a metal fluoride-functionalized proton-exchange solid support presenting a metal fluoride group linked to a phosphorous (P) atom by way of an oxygen (O) atom. As shown, a proton-exchange solid support 402 is modified with a metal tetrafluoride 404 to produce metal fluoride-functionalized proton-exchange solid support 406.

Proton-exchange solid support 402 includes a solid support 408, a linker chain 410, and a phosphonic acid group 412. However, linker chain 410 is optional and may be omitted in other examples. Solid support 408 may be implemented by any solid support described herein (e.g., solid support 208) and may be implemented in any suitable form, including as a porous structural framework (e.g., porous structural framework 102) or a solid support particle (e.g., solid support particle 110). In some examples, proton-exchange solid support 402 comprises a phosphonic acid-functionalized polymer, such as a polyvinyl phosphonic acid (PVPA) polymer.

Linker chain 410 links phosphonic acid group 412 to solid support 408. Linker chain 410 may be implemented by any suitable linker chain, including any linker chain described herein (e.g., linker chain R of formula (Ib) or linker chain 210).

Metal tetrafluoride 404 comprises a metal fluoride of formula MF₄ comprising a tetravalent metal (M) atom covalently bonded to four fluorine (F) atoms. However, metal (M) atom is multivalent and thus is able to expand its valence to covalently bond with a fifth atom and thereby form a pentavalent structure with a negative formal charge. Metal (M) atom may be any suitable metal described above with reference to general formulas (Ia) and (Ib), such as silicon (Si), germanium (Ge), tin (Sn), or zirconium (Zr).

In some examples, metal tetrafluoride 404 and phosphonic acid group 412 are combined in approximately a one-to-one (1:1) stoichiometric ratio, although they may be combined in any other suitable ratio. The proton-exchange solid support 402 and metal tetrafluoride 404 may be combined in the presence of any suitable reaction solvent, such as deionized water and/or water-miscible organic solvents including acetonitrile, dimethylformamide, N-methylpyrrolidone, and/or dimethylacetamide. The resulting metal fluoride-functionalized proton-exchange solid support 406 includes a proton-exchange solid support 414 comprising a phosphorous (P) atom covalently bonded to an oxygen (O) atom, and a metal fluoride group 416 comprising a pentavalent metal (M) atom covalently bonded to the oxygen (O) atom and to four fluorine (F) atoms. As can be seen in FIG. 4A, the pentavalent metal fluoride group 416 has a negative formal charge. Thus, metal fluoride group 416 is intrinsically ionic and serves as a proton transport agent.

FIG. 4B shows an illustrative reaction scheme 400B for synthesizing a metal fluoride-functionalized proton-exchange solid support presenting a metal fluoride group linked to a phosphorous (P) atom through two oxygen (O) atoms. Reaction scheme 400B is similar to reaction scheme 400A except that, in reaction scheme 400B, the metal fluoride 418 combines with two oxygen (O) atoms in phosphonic acid group 412, thereby expanding the coordination number of the metal (M) atom to six and forming a hexavalent structure. The resulting metal fluoride-containing proton-exchange solid support 420 includes a proton-exchange solid support 414 comprising a phosphorous (P) atom covalently bonded to two oxygen (O) atoms, and a metal fluoride group 422 comprising a hexavalent metal (M) atom covalently bonded to both oxygen (O) atoms and to four fluorine (F) atoms. As can be seen in FIG. 4B, the hexavalent metal fluoride group 422 has a negative two (−2) formal charge. Thus, metal fluoride group 422 is intrinsically ionic and serves as a proton transport agent.

In the example of FIG. 4B, metal tetrafluoride 418 combines with two oxygen (O) atoms in phosphonic acid group 412, thereby expanding the coordination number of the metal (M) atom to six and forming a hexavalent structure. In alternative examples (not shown), metal fluoride 418 may combine with an oxygen (O) atom in each of two different phosphonic acid groups 412, similar to the examples of FIGS. 2B and 3B, thereby expanding the coordination number of the metal (M) atom to six and forming a hexavalent structure.

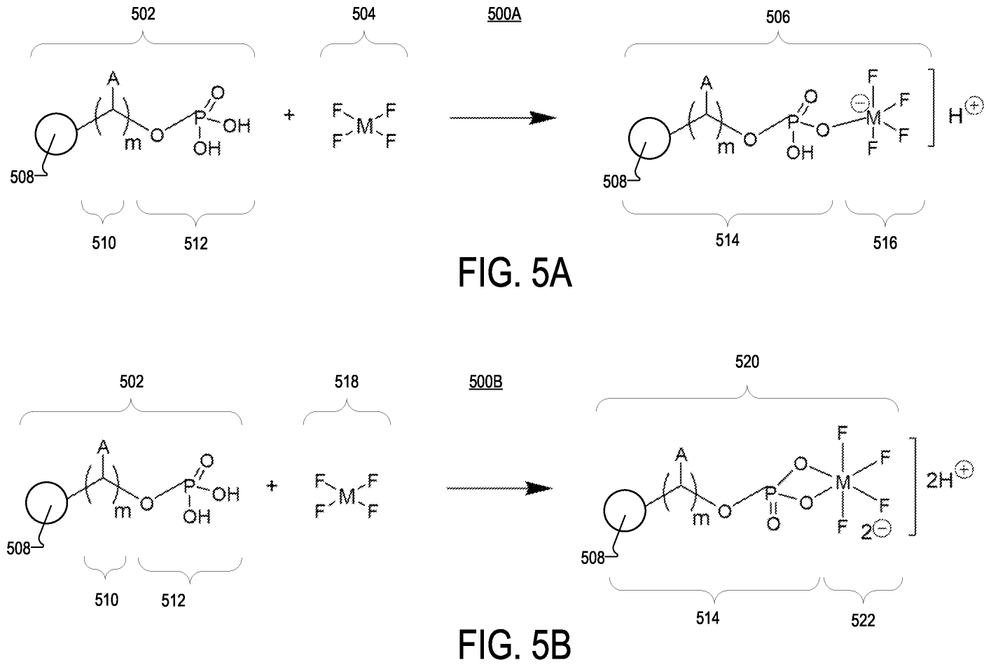

FIG. 5A shows another illustrative reaction scheme 500A for synthesizing a metal fluoride-functionalized proton-exchange solid support presenting a metal fluoride group linked to a phosphorous (P) atom by way of an oxygen (O) atom. As shown, a proton-exchange solid support 502 is modified with a metal tetrafluoride 504 to produce metal fluoride-functionalized proton-exchange solid support 506.

Proton-exchange solid support 502 includes a solid support 508, a linker chain 510, and a monophosphate group 512. However, linker chain 510 is optional and may be omitted in other examples. Solid support 508 may be implemented by any solid support described herein (e.g., solid support 208) and may be implemented in any suitable form, including as a porous structural framework (e.g., porous structural framework 102) or a solid support particle (e.g., solid support particle 110). In some examples, proton-exchange solid support 502 comprises a phosphate-functionalized polymer.

Linker chain 510 links monophosphate group 512 to solid support 508. Linker chain 510 may be implemented by any suitable linker chain, including any linker chain described herein (e.g., linker chain R of formula (Ib) or linker chain 210).

Metal tetrafluoride 504 comprises a metal fluoride of formula MF₄ comprising a tetravalent metal (M) atom covalently bonded to four fluorine (F) atoms. However, metal (M) atom is multivalent and thus is able to expand its valence to covalently bond with a fifth atom and thereby form a pentavalent structure with a negative formal charge. Metal (M) atom may be any suitable metal described above with reference to general formulas (Ia) and (Ib), such as silicon (Si), germanium (Ge), tin (Sn), or zirconium (Zr).

In some examples, metal tetrafluoride 504 and monophosphate group 512 are combined in approximately a one-to-one (1:1) stoichiometric ratio, although they may be combined in any other suitable ratio. The proton-exchange solid support 502 and metal tetrafluoride 504 may be combined in the presence of any suitable reaction solvent, such as deionized water and/or water-miscible organic solvents including acetonitrile, dimethylformamide, N-methylpyrrolidone, and/or dimethylacetamide. The resulting metal fluoride-functionalized proton-exchange solid support 506 includes a proton-exchange solid support 514 comprising a phosphorous (P) atom covalently bonded to an oxygen (O) atom, and a metal fluoride group 516 comprising a pentavalent metal (M) atom covalently bonded to the oxygen (O) atom and to four fluorine (F) atoms. As can be seen in FIG. 5A, the pentavalent metal fluoride group 516 has a negative formal charge. Thus, metal fluoride group 516 is intrinsically ionic and serves as a proton transport agent.

FIG. 5B shows an illustrative reaction scheme 500B for synthesizing a metal fluoride-functionalized proton-exchange solid support presenting a metal fluoride group linked to a phosphorous (P) atom through two oxygen (O) atoms. Reaction scheme 500B is similar to reaction scheme 500A except that, in reaction scheme 500B, the metal fluoride 518 combines with two oxygen (O) atoms in monophosphate group 512, thereby expanding the coordination number of the metal (M) atom to six and forming a hexavalent structure. The resulting metal fluoride-containing proton-exchange solid support 520 includes a proton-exchange solid support 514 comprising a phosphorous (P) atom covalently bonded to two oxygen (O) atoms, and a metal fluoride group 522 comprising a hexavalent metal (M) atom covalently bonded to both oxygen (O) atoms and to four fluorine (F) atoms. As can be seen in FIG. 5B, the hexavalent metal fluoride group 522 has a negative two (−2) formal charge. Thus, metal fluoride group 522 is intrinsically ionic and serves as a proton transport agent.

In the example of FIG. 5B, metal tetrafluoride 418 combines with two oxygen (O) atoms in monophosphate group 512, thereby expanding the coordination number of the metal (M) atom to six and forming a hexavalent structure. In alternative examples, metal fluoride 518 may combine with an oxygen (O) atom in each of two different monophosphate groups 512, thereby expanding the coordination number of the metal (M) atom to six and forming a hexavalent structure with a negative two (−2) formal charge.

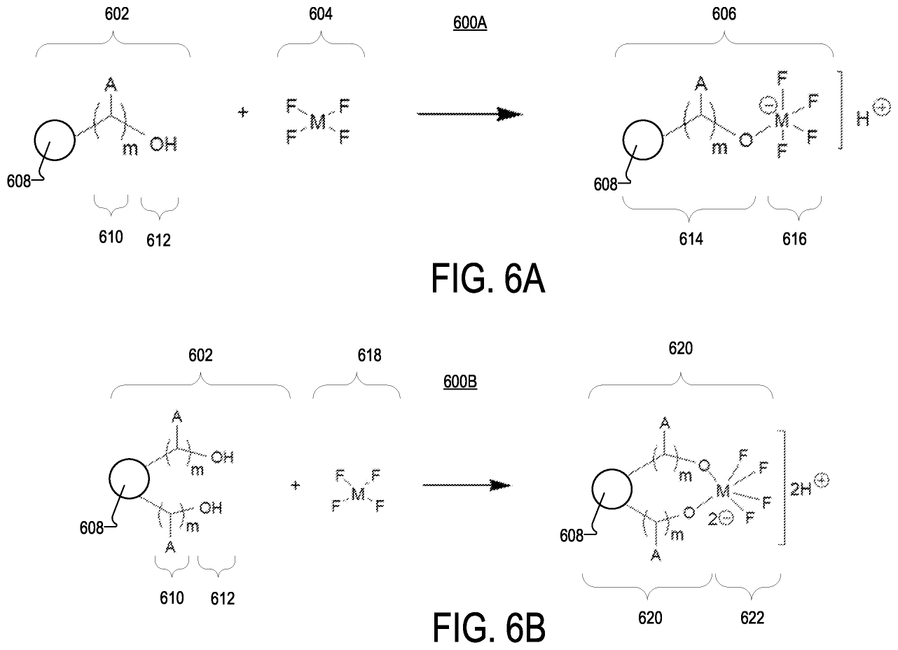

FIG. 6A shows an illustrative reaction scheme 600A for synthesizing a metal fluoride-functionalized proton-exchange solid support presenting a metal fluoride group linked to a solid support by way of an oxygen (O) atom. As shown, a proton-exchange solid support 602 is modified with metal tetrafluoride 604 to produce metal fluoride-functionalized proton-exchange solid support 606.

Proton-exchange solid support 602 includes a solid support 608, a linker chain 610, and a hydroxyl group 612. However, linker chain 610 is optional and may be omitted in other examples. Solid support 608 may be implemented by any solid support described herein (e.g., solid support 208) and may be implemented in any suitable form, including as a porous structural framework (e.g., porous structural framework 102) or a solid support particle (e.g., solid support particle 110). In some examples, proton-exchange solid support 602 comprises a natural polymer, such as lignin, cellulose, or chitin.

Linker chain 610 links hydroxyl group 612 to solid support 608. Linker chain 610 may be implemented by any suitable linker chain, including any linker chain described herein (e.g., linker chain R of formula (Ib) or linker chain 210).

Metal tetrafluoride 604 comprises a metal fluoride of formula MF₄ comprising a tetravalent metal (M) atom covalently bonded to four fluorine (F) atoms. However, metal (M) atom is multivalent and thus is able to expand its valence to covalently bond with a fifth atom and thereby form a pentavalent structure with a negative formal charge. Metal (M) atom may be any suitable metal described above with reference to general formulas (Ia) and (Ib), such as silicon (Si), germanium (Ge), tin (Sn), or zirconium (Zr).

In some examples, metal tetrafluoride 604 and hydroxyl group 612 are combined in approximately a one-to-one (1:1) stoichiometric ratio, although they may be combined in any other suitable ratio. The proton-exchange solid support 602 and metal tetrafluoride 604 may be combined in the presence of any suitable reaction solvent, such as deionized water and/or water-miscible organic solvents including acetonitrile, dimethylformamide, N-methylpyrrolidone, and/or dimethylacetamide. The resulting metal fluoride-functionalized proton-exchange solid support 606 includes a proton-exchange solid support 614 comprising a solid support 608 bonded to an oxygen (O) atom, and a metal fluoride group 616 comprising a metal (M) atom covalently bonded to the oxygen (O) atom and to four fluorine (F) atoms. As can be seen in FIG. 6A, the pentavalent metal fluoride group 616 has a negative formal charge. Thus, metal fluoride group 616 is intrinsically ionic and serves as a proton transport agent

FIG. 6B shows an illustrative reaction scheme 600B for synthesizing a metal fluoride-functionalized proton-exchange solid support presenting a metal fluoride group linked to a solid support through two oxygen (O) atoms. Reaction scheme 600B is similar to reaction scheme 600A except that, in reaction scheme 600B, a single metal tetrafluoride 618 combines with an oxygen (O) atom in each of two different hydroxyl groups 612, thereby expanding the coordination number of the metal (M) atom to six and forming a hexavalent structure. The resulting metal fluoride-containing proton-exchange solid support 620 includes a proton-exchange solid support 614 comprising a solid support 608 bonded to two oxygen (O) atoms, and a metal fluoride group 622 comprising a hexavalent metal (M) atom covalently bonded to both oxygen (O) atoms and to four fluorine (F) atoms. As can be seen in FIG. 6B, the metal fluoride group 622 has a negative two (−2) formal charge. Thus, metal fluoride group 622 is intrinsically ionic and serves as a proton transport agent.

While FIG. 6B shows that metal tetrafluoride 618 combines with two hydroxyl groups 612 from the same solid support 608, metal tetrafluoride 618 may alternatively combine with two hydroxyl groups 612 from different solid supports 608. Moreover, metal tetrafluoride 618 may alternatively combine with two different types of proton-dissociative groups connected to the same or different solid supports 608, including any of the proton-dissociative groups described herein.

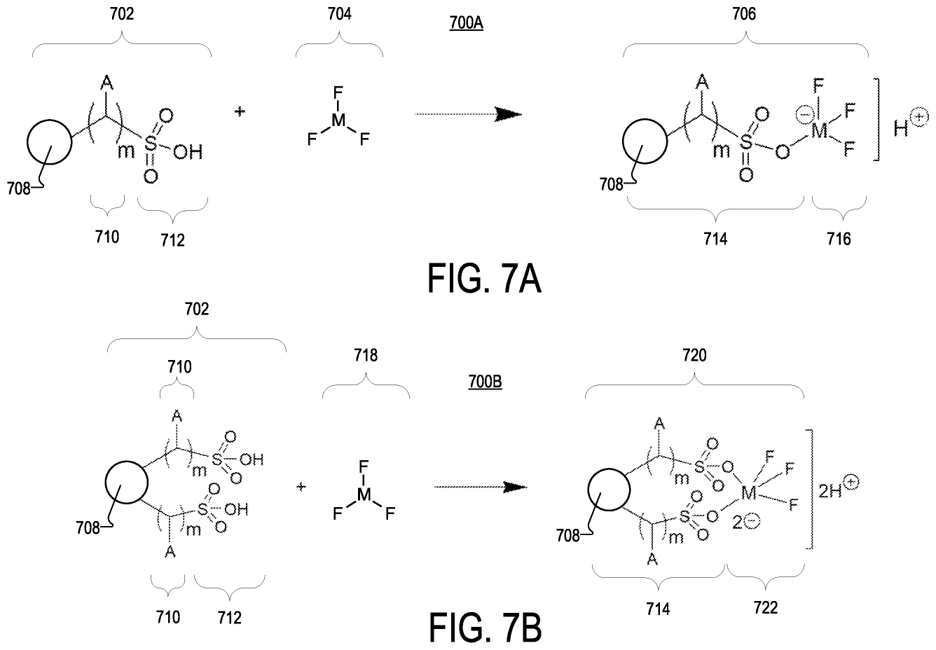

In some examples, a metal fluoride-functionalized proton-exchange solid support is synthesized by combining a proton-exchange solid support with metal trifluoride (MF₃), as will now be shown and described with reference to FIGS. 7A-12B. In the examples that follow, the metal (M) atom has three valence electrons and covalently bonds with three fluorine (F) atoms, but may expand its valence by covalently bonding with four, five, or six total atoms to form a tetravalent, pentavalent, or hexavalent structure with a negative one (−1), negative two (−2), or negative three (−3) formal charge. The metal (M) atom may be any suitable metal described above with reference to general formulas (Ia) and (Ib), such as aluminum (Al) or gallium (Ga), which may expand their valence from three to four by covalently bonding with four total atoms, or indium (In), which may expand its valence from three to four, five, or six by covalently bonding with four, five, or six total atoms, respectively. The following reaction schemes are merely illustrative and are not limiting.

FIG. 7A shows an illustrative reaction scheme 700A for synthesizing a metal fluoride-functionalized proton-exchange solid support presenting a metal fluoride group linked to a sulfur (S) atom by way of an oxygen (O) atom. As shown, a proton-exchange solid support 702 is modified with a metal trifluoride 704 to produce a metal fluoride-containing proton-exchange solid support 706. Proton-exchange solid support 702 includes a solid support 708, a linker chain 710, and a sulfonic acid group 712, which are similar to solid support 208, linker chain 210, and sulfonic acid group 212 of FIG. 2A. Reaction scheme 700A is similar to reaction scheme 200A except that, in reaction scheme 700A, proton-exchange solid support 702 is combined with a metal trifluoride 704 instead of with metal tetrafluoride 204 to produce metal fluoride-functionalized proton-exchange solid support 706. Metal trifluoride 704 comprises a metal (M) atom that may expand its valence from three to four, such as aluminum (Al), gallium (Ga), or indium (In)), and thereby form a tetravalent structure with a negative formal charge. Metal fluoride-containing proton-exchange solid support 706 includes a proton-exchange solid support 714 comprising a sulfur atom covalently bonded to an oxygen (O) atom, and a metal fluoride group 716 comprising a tetravalent metal (M) atom covalently bonded to the oxygen (O) atom and to three fluorine (F) atoms. Metal (M) atom has three valence electrons but forms a tetravalent structure with a negative formal charge by covalently bonding with four atoms, as shown in FIG. 7A. Thus, metal fluoride group 716 is intrinsically ionic and serves as a proton transport agent.

FIG. 7B shows an illustrative reaction scheme 700B for synthesizing a metal fluoride-functionalized proton-exchange solid support presenting a pentavalent metal fluoride group linked to two sulfur (S) atoms through two oxygen (O) atoms. Reaction scheme 700B is similar to reaction scheme 700A except that, in reaction scheme 700B, metal trifluoride 718 combines with two different sulfonic acid groups 712 to produce metal fluoride-containing proton-exchange solid support 720. Metal trifluoride 718 comprises a metal (M) atom that may expand its valence from three to five, such as indium (In), and thereby form a pentavalent structure with a negative two (−2) formal charge. Metal fluoride-containing proton-exchange solid support 720 includes a proton-exchange solid support 714 comprising two sulfur (S) atoms each covalently bonded to an oxygen (O) atom, and a metal fluoride group 722 comprising a pentavalent metal (M) atom (e.g., indium (In)) covalently bonded to two oxygen (O) atoms and to three fluorine (F) atoms. As can be seen in FIG. 7B, the pentavalent metal fluoride group 722 has a negative two (−2) formal charge. Thus, metal fluoride group 722 is intrinsically ionic and serves as a proton transport agent.

While FIG. 7B shows that metal trifluoride 718 combines with two sulfonic acid groups 712 from the same solid support 708 (e.g., a same solid support particle), metal trifluoride 718 may alternatively combine with two sulfonic acid groups 712 from different solid supports 708. Moreover, metal trifluoride 718 may alternatively combine with two different types of proton-dissociative groups (e.g., acid groups) connected to the same or different solid supports 708, including any of the proton-dissociative groups described herein.

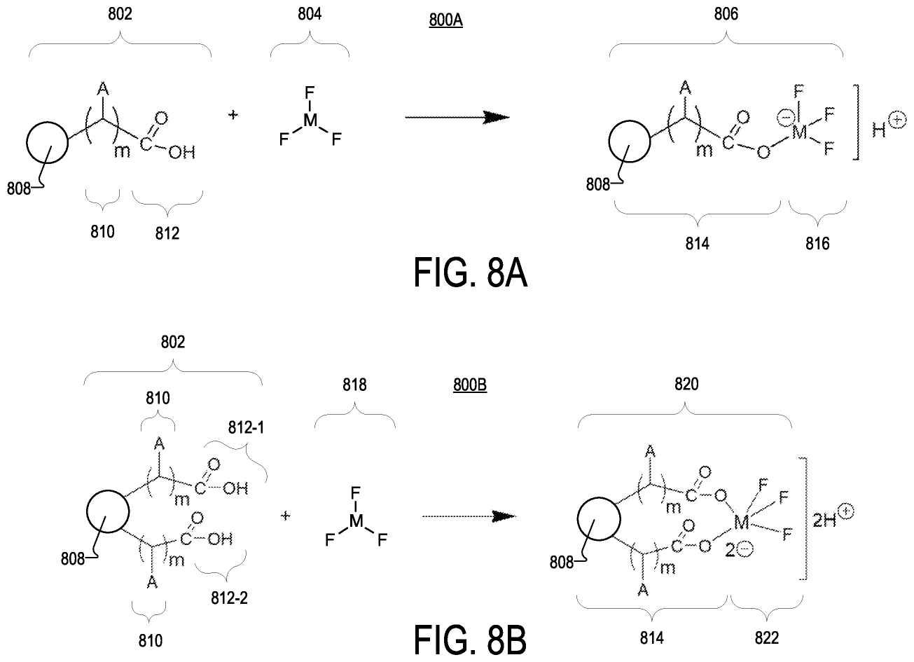

FIG. 8A shows an illustrative reaction scheme 800A for synthesizing a metal fluoride-functionalized proton-exchange solid support presenting a metal fluoride group linked to a carbon (C) atom by way of an oxygen (O) atom. Reaction scheme 800A is similar to reaction scheme 300A except that, in reaction scheme 800A, proton-exchange solid support 802 is combined with a metal trifluoride 804 instead of with metal tetrafluoride 304 to produce metal fluoride-functionalized proton-exchange solid support 806. Proton-exchange solid support 802 includes a solid support 808, a linker chain 810, and a carboxylic acid group 812, which are similar to solid support 308, linker chain 310, and sulfonic acid group 312 of FIG. 3A. Metal trifluoride 804 comprises a metal (M) atom that may expand its valence from three to four, such as aluminum (Al), gallium (Ga), or indium (In)), and thereby form a tetravalent structure with a negative formal charge. Metal fluoride-functionalized proton-exchange solid support 806 includes a proton-exchange solid support 814 comprising a carbon atom covalently bonded to an oxygen atom, and a metal fluoride group 816 comprising a metal (M) atom covalently bonded to the oxygen atom and to three fluorine (F) atoms, thereby forming a tetravalent metal fluoride structure. As can be seen in FIG. 8A, the tetravalent metal fluoride group 816 has a negative formal charge. Thus, metal fluoride group 816 is intrinsically ionic and serves as a proton transport agent.

FIG. 8B shows an illustrative reaction scheme 800B for synthesizing a metal fluoride-functionalized proton-exchange solid support presenting a metal fluoride group linked to two carbon (C) atoms through two oxygen (O) atoms. Reaction scheme 800B is similar to reaction scheme 300B except that, in reaction scheme 800B, a single metal trifluoride 818 combines with an oxygen (O) atom in each of two different carboxylic acid groups 812 (e.g., an oxygen (O) atom in each of two different carboxylic acid groups 812-1 and 812-2), thereby expanding the coordination number of the metal (M) atom to five and forming a pentavalent structure. Metal trifluoride 818 comprises a metal (M) atom that may expand its valence from three to five, such as indium (In), and thereby form a pentavalent structure with a negative two (−2) formal charge. The resulting metal fluoride-containing proton-exchange solid support 820 includes a proton-exchange solid support 814 comprising two carbon (C) atoms each covalently bonded to an oxygen (O) atom, and a metal fluoride group 822 comprising a pentavalent metal (M) atom covalently bonded to both oxygen (O) atoms and to three fluorine (F) atoms. As can be seen in FIG. 8B, the metal fluoride group 822 has a negative two (−2) formal charge. Thus, metal fluoride group 822 is intrinsically ionic and serves as a proton transport agent.

While FIG. 8B shows that metal trifluoride 818 combines with two carboxylic acid groups 812 from the same solid support 808, metal trifluoride 818 may alternatively combine with two carboxylic acid groups 812 from different solid supports 808. Moreover, metal trifluoride 818 may alternatively combine with two different types of proton-dissociative groups connected to the same or different solid supports 808, including any of the proton-dissociative groups described herein.

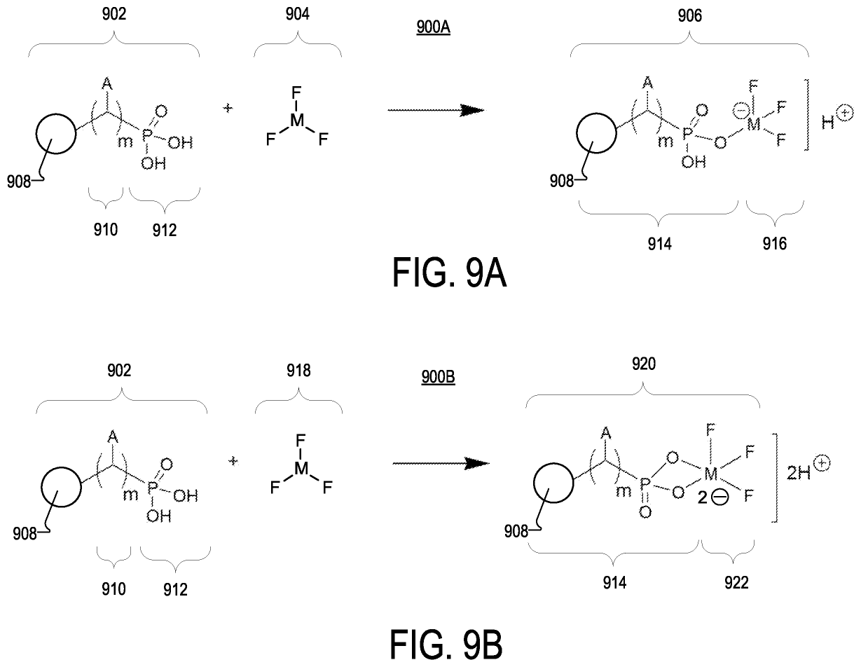

FIG. 9A shows an illustrative reaction scheme 900A for synthesizing a metal fluoride-functionalized proton-exchange solid support presenting a metal fluoride group linked to a phosphorous (P) atom by way of an oxygen (O) atom. Reaction scheme 900A is similar to reaction scheme 400A except that, in reaction scheme 900A, proton-exchange solid support 902 is combined with a metal trifluoride 904 instead of with metal tetrafluoride 404 to produce metal fluoride-functionalized proton-exchange solid support 906. Proton-exchange solid support 902 includes a solid support 908, a linker chain 910, and a phosphonic acid group 912, which are similar to solid support 408, linker chain 410, and phosphonic acid group 412 of FIG. 4A. Metal trifluoride 904 comprises a metal (M) atom that may expand its valence from three to four, such as aluminum (Al), gallium (Ga), or indium (In)), and thereby form a tetravalent structure with a negative formal charge. Metal fluoride-functionalized proton-exchange solid support 906 includes a proton-exchange solid support 914 comprising a phosphorous (P) atom covalently bonded to an oxygen (O) atom, and a metal fluoride group 916 comprising a tetravalent metal (M) atom covalently bonded to the oxygen (O) atom and to three fluorine (F) atoms. As can be seen in FIG. 9A, the tetravalent metal fluoride group 916 has a negative formal charge. Thus, metal fluoride group 916 is intrinsically ionic and serves as a proton transport agent.

FIG. 9B shows an illustrative reaction scheme 900B for synthesizing a metal fluoride-functionalized proton-exchange solid support presenting a metal fluoride group linked to a phosphorous (P) atom through two oxygen (O) atoms. Reaction scheme 900B is similar to reaction scheme 900A except that, in reaction scheme 900B, the metal trifluoride 918 combines with two oxygen (O) atoms in phosphonic acid group 912, thereby expanding the coordination number of the metal (M) atom to five and forming a pentavalent structure. Metal trifluoride 918 comprises a metal (M) atom that may expand its valence from three to five, such as indium (In), and thereby form a pentavalent structure with a negative two (−2) formal charge. The resulting metal fluoride-containing proton-exchange solid support 920 includes a proton-exchange solid support 914 comprising a phosphorous (P) atom covalently bonded to two oxygen (O) atoms, and a metal fluoride group 922 comprising a pentavalent metal (M) atom covalently bonded to both oxygen (O) atoms and to three fluorine (F) atoms. As can be seen in FIG. 9B, the pentavalent metal fluoride group 922 has a negative two (−2) formal charge. Thus, metal fluoride group 922 is intrinsically ionic and serves as a proton transport agent.

In the example of FIG. 9B, metal trifluoride 918 combines with two oxygen (O) atoms in phosphonic acid group 912, thereby expanding the coordination number of the metal (M) atom to five and forming a pentavalent structure with a negative two (−2) formal charge. In alternative examples (not shown), metal trifluoride 918 combines with an oxygen (O) atom in each of two different phosphonic acid groups 912, thereby expanding the coordination number of the metal (M) atom to five and forming a pentavalent structure with a negative two (−2) formal charge.

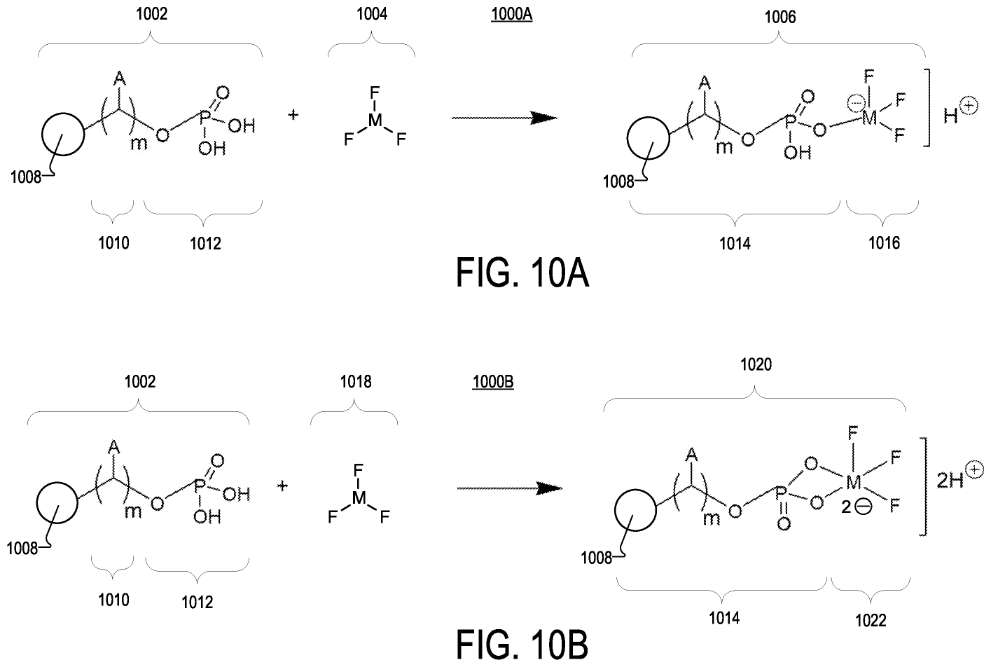

FIG. 10A shows another illustrative reaction scheme 1000A for synthesizing a metal fluoride-functionalized proton-exchange solid support presenting a metal fluoride group linked to a phosphorous (P) atom by way of an oxygen (O) atom. Reaction scheme 1000A is similar to reaction scheme 500A except that, in reaction scheme 1000A, proton-exchange solid support 1002 is combined with a metal trifluoride 1004 instead of with metal tetrafluoride 504 to produce metal fluoride-functionalized proton-exchange solid support 1006. Proton-exchange solid support 1002 includes a solid support 1008, a linker chain 1010, and a monophosphate group 1012, which are similar to solid support 508, linker chain 510, and monophosphate group 512 of FIG. 5A. Metal trifluoride 1004 comprises a metal (M) atom that may expand its valence from three to four, such as aluminum (Al), gallium (Ga), or indium (In)), and thereby form a tetravalent structure with a negative formal charge. Metal fluoride-functionalized proton-exchange solid support 1006 includes a proton-exchange solid support 1014 comprising a phosphorous (P) atom covalently bonded to an oxygen (O) atom, and a metal fluoride group 1016 comprising a tetravalent metal (M) atom covalently bonded to the oxygen (O) atom and to three fluorine (F) atoms. As can be seen in FIG. 10A, the tetravalent metal fluoride group 1016 has a negative formal charge. Thus, metal fluoride group 1016 is intrinsically ionic and serves as a proton transport agent.

FIG. 10B shows an illustrative reaction scheme 1000B for synthesizing a metal fluoride-functionalized proton-exchange solid support presenting a metal fluoride group linked to a phosphorous (P) atom through two oxygen (O) atoms. Reaction scheme 1000B is similar to reaction scheme 1000A except that, in reaction scheme 1000B, metal trifluoride 1018 combines with two oxygen (O) atoms in monophosphate group 1012, thereby expanding the coordination number of the metal (M) atom to five and forming a pentavalent structure. Metal trifluoride 1018 comprises a metal (M) atom that may expand its valence from three to five, such as indium (In), and thereby form a pentavalent structure with a negative two (−2) formal charge. The resulting metal fluoride-containing proton-exchange solid support 1020 includes a proton-exchange solid support 1014 comprising a phosphorous (P) atom covalently bonded to two oxygen (O) atoms, and a metal fluoride group 1022 comprising a pentavalent metal (M) atom covalently bonded to both oxygen (O) atoms and to three fluorine (F) atoms. As can be seen in FIG. 10B, the pentavalent metal fluoride group 1022 has a negative two (−2) formal charge. Thus, metal fluoride group 1022 is intrinsically ionic and serves as a proton transport agent.

In the example of FIG. 10B, metal trifluoride 1018 combines with two oxygen (O) atoms in monophosphate group 1012, thereby expanding the coordination number of the metal (M) atom to five and forming a pentavalent structure. In alternative examples, metal fluoride 1018 combines with an oxygen (O) atom in each of two different monophosphate groups 1012, similar to the examples of FIGS. 7B and 8B, thereby expanding the coordination number of the metal (M) atom to five and forming a pentavalent structure with a negative two (−2) formal charge.

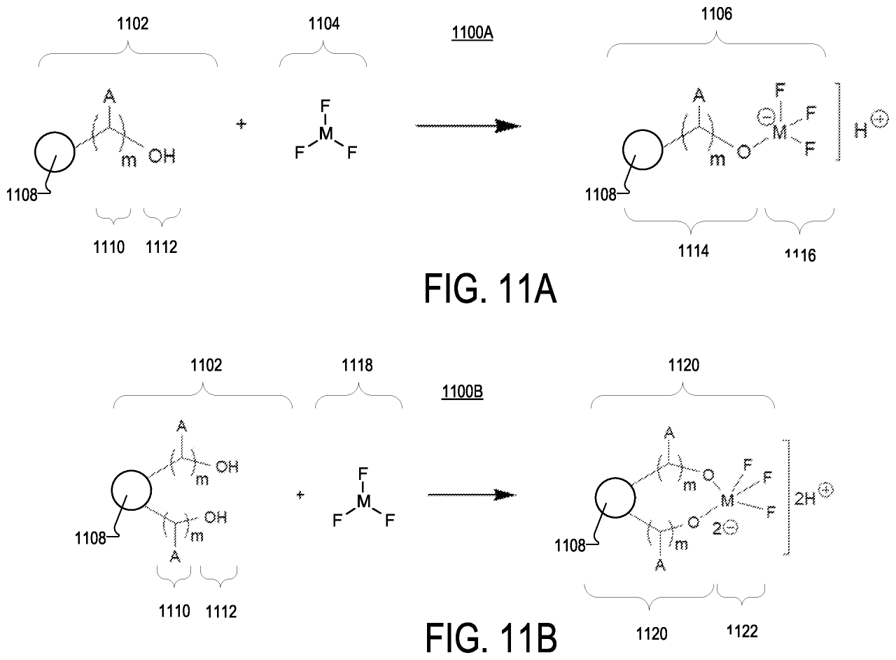

FIG. 11A shows an illustrative reaction scheme 1100A for synthesizing a metal fluoride-functionalized proton-exchange solid support presenting a metal fluoride group linked to a solid support by way of an oxygen (O) atom. Reaction scheme 1100A is similar to reaction scheme 600A except that, in reaction scheme 1100A, proton-exchange solid support 1102 is combined with a metal trifluoride 1104 instead of with metal tetrafluoride 604 to produce metal fluoride-functionalized proton-exchange solid support 1106. Proton-exchange solid support 1102 includes a solid support 1108, a linker chain 1110, and a sulfonic acid group 1112, which are similar to solid support 608, linker chain 610, and hydroxyl group 612 of FIG. 6A. Metal trifluoride 1104 comprises a metal (M) atom that may expand its valence from three to four, such as aluminum (Al), gallium (Ga), or indium (In)), and thereby form a tetravalent structure with a negative formal charge. Metal fluoride-functionalized proton-exchange solid support 1106 includes a proton-exchange solid support 1114 comprising a solid support 1108 bonded to an oxygen (O) atom, and a metal fluoride group 1116 comprising a metal (M) atom covalently bonded to the oxygen (O) atom and to three fluorine (F) atoms, thereby forming a tetravalent metal fluoride structure. As can be seen in FIG. 11A, the tetravalent metal fluoride group 1116 has a negative formal charge. Thus, metal fluoride group 1116 is intrinsically ionic and serves as a proton transport agent.

FIG. 11B shows an illustrative reaction scheme 1100B for synthesizing a metal fluoride-functionalized proton-exchange solid support presenting a metal fluoride group linked to a solid support through two oxygen (O) atoms. Reaction scheme 1100B is similar to reaction scheme 1100A except that, in reaction scheme 1100B, a single metal trifluoride 1118 combines with an oxygen (O) atom in each of two different hydroxyl groups 1112, thereby expanding the coordination number of the metal (M) atom to five and forming a pentavalent structure. Metal trifluoride 1118 comprises a metal (M) atom that may expand its valence from three to five, such as indium (In), and thereby form a pentavalent structure with a negative two (−2) formal charge. The resulting metal fluoride-containing proton-exchange solid support 1120 includes a proton-exchange solid support 1114 comprising a solid support 1108 bonded to two oxygen (O) atoms, and a metal fluoride group 1122 comprising a pentavalent metal (M) atom covalently bonded to both oxygen (O) atoms and to three fluorine (F) atoms. As can be seen in FIG. 11B, the metal fluoride group 1122 has a negative two (−2) formal charge. Thus, metal fluoride group 1122 is intrinsically ionic and serves as a proton transport agent.

While FIG. 11B shows that metal trifluoride 1118 combines with two hydroxyl groups 1112 from the same solid support 1108, metal trifluoride 1118 may alternatively combine with two hydroxyl groups 1112 from different solid supports 1108. Moreover, metal trifluoride 1118 may alternatively combine with two different types of proton-dissociative groups connected to the same or different solid supports 1108, including any of the proton-dissociative groups described herein.

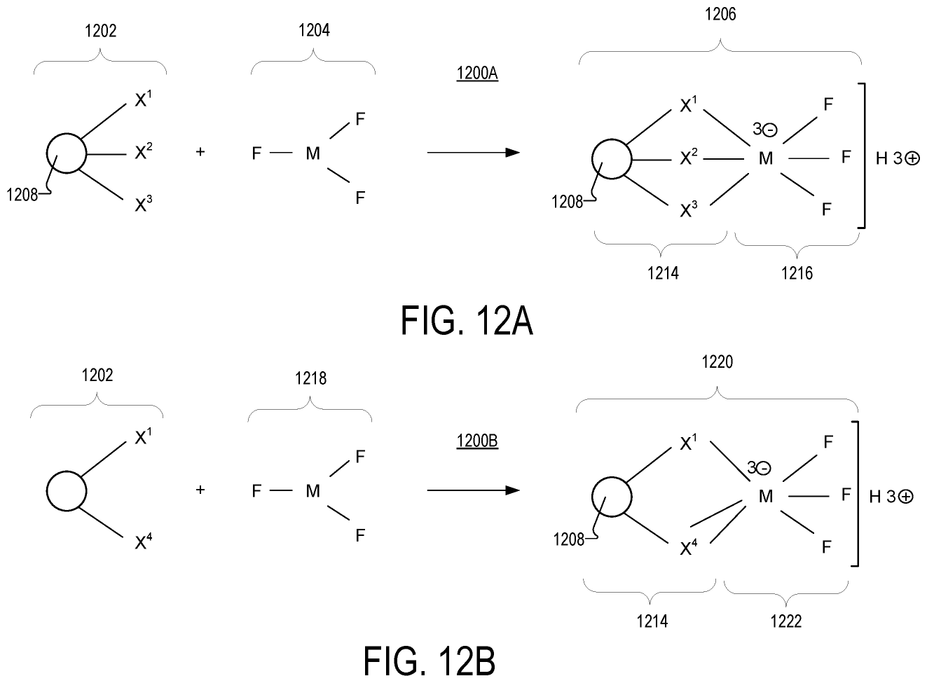

FIG. 12A shows an illustrative reaction scheme 1200A for synthesizing a metal fluoride-functionalized proton-exchange solid support presenting a metal fluoride group linked to one to three sulfur (S), carbon (C), and/or phosphorous (P) atoms by way of three oxygen (O) atoms. As shown, a proton-exchange solid support 1202 is modified with a metal trifluoride 1204 to produce a metal fluoride-containing proton-exchange solid support 1206.

Proton-exchange solid support 1202 includes a solid support 1208 and three substituent groups X¹, X², and X³. In some examples, proton-exchange solid support 1202 also includes one or more linker chains R (not shown) that link substituent groups X¹, X², and/or X³ to solid support 1208.

Solid support 1208 may be formed of any inorganic and/or organic material described herein. As shown, solid support 1208 is a solid support particle (e.g., solid support particle 110). However, in other examples solid support 1208 is any other suitable solid support, including a porous structural framework (e.g., porous structural framework 102).

Metal trifluoride 1204 is a metal fluoride of formula MF₃ comprising a trivalent metal (M) atom, such as indium (In), that is able to expand its valence from three to six by bonding with six total atoms and thereby form a hexavalent structure with a negative three (−3) formal charge.

Substituent groups X¹, X², and X³ may be the same or different and may each be represented by substituent group X of formula (Ia) described above. Thus, substituent groups X¹, X², and X³ each includes a sulfur (S), a carbon (C), and/or a phosphorous (P) atom covalently bonded to an oxygen (O) atom. For example, substituent groups X¹, X², and X³ may be or include a proton-dissociative substituent group, such as a hydroxyl group, an acid group (e.g., an oxoacid such as a carboxylic acid group, a sulfonic acid group (e.g., a sulfo group), a phosphonic acid group, or a phosphate group (e.g., a monophosphate group)), or an alcohol (e.g., a phenol group).

In some examples, metal trifluoride 1204 and substituent groups X¹, X², and X³ are combined in approximately a one-to-three (1:3) stoichiometric ratio, although they may be combined in any other suitable ratio. The proton-exchange solid support 1202 and metal trifluoride 1204 may be combined in the presence of any suitable reaction solvent, such as deionized water and/or water-miscible organic solvents including acetonitrile, dimethylformamide, N-methylpyrrolidone, and/or dimethylacetamide. The resulting metal fluoride-containing proton-exchange solid support 1206 includes a proton-exchange solid support 1214 comprising a metal fluoride group 1216 comprising a hexavalent metal (M) atom (e.g., indium (In)) covalently bonded to three oxygen (O) atoms in substituent groups X¹, X², and X³ and to three fluorine (F) atoms. As mentioned above, metal (M) atom has three valence electrons but forms a hexavalent structure with a negative three (−3) formal charge by covalently bonding with six atoms, as shown in FIG. 12A. Thus, metal fluoride group 1216 is intrinsically ionic and serves as a proton transport agent.

FIG. 12B shows another illustrative reaction scheme 1200B for synthesizing a metal fluoride-functionalized proton-exchange solid support presenting a metal fluoride group. Reaction scheme 1200B is similar to reaction scheme 1200A except that, in reaction scheme 1200B, metal trifluoride 1218 combines with three oxygen (O) atoms in two substituent groups X¹ and X⁴ to produce a metal fluoride-containing proton-exchange solid support 1220. Substituent group X⁴ has at least two pendant hydroxyl groups (e.g., a monophosphate group). The metal trifluoride 1218 is similar to metal trifluoride 1204 and combines with one oxygen (O) atom in substituent group X¹ and with two oxygen (O) atoms in substituent group X⁴, thereby expanding the coordination number of the metal (M) atom to six and forming a hexavalent structure. The resulting metal fluoride-containing proton-exchange solid support 1220 includes a proton-exchange solid support 1214 comprising: (i) a substituent group X¹ having a first atom (e.g., a sulfur (S) atom, a carbon (C) atom, or a phosphorous (P) atom) covalently bonded to a first oxygen atom; (ii) a substituent group X⁴ having a second atom (e.g., a phosphorous (P) atom) covalently bonded to second and third oxygen (O) atoms; and (iii) a metal fluoride group 1222 comprising a hexavalent metal (M) atom covalently bonded to each of the first, second, and third oxygen (O) atoms and to three fluorine (F) atoms. As can be seen in FIG. 12B, the hexavalent metal fluoride group 1222 has a negative three (−3) formal charge. Thus, metal fluoride group 1222 is intrinsically ionic and serves as a proton transport agent.

In the examples of FIGS. 2A to 6B, a proton-exchange solid support combines with a metal tetrafluoride (MF₄), and in the examples of FIGS. 7A to 12B a proton-exchange solid support combines with a metal trifluoride (MF₃). However, a proton-exchange solid support may combine with both metal tetrafluoride (MF₄) and metal trifluoride (MF₃) in any suitable ratio. Furthermore, multiple different metal tetrafluorides and/or metal trifluorides may be used in any suitable combination.

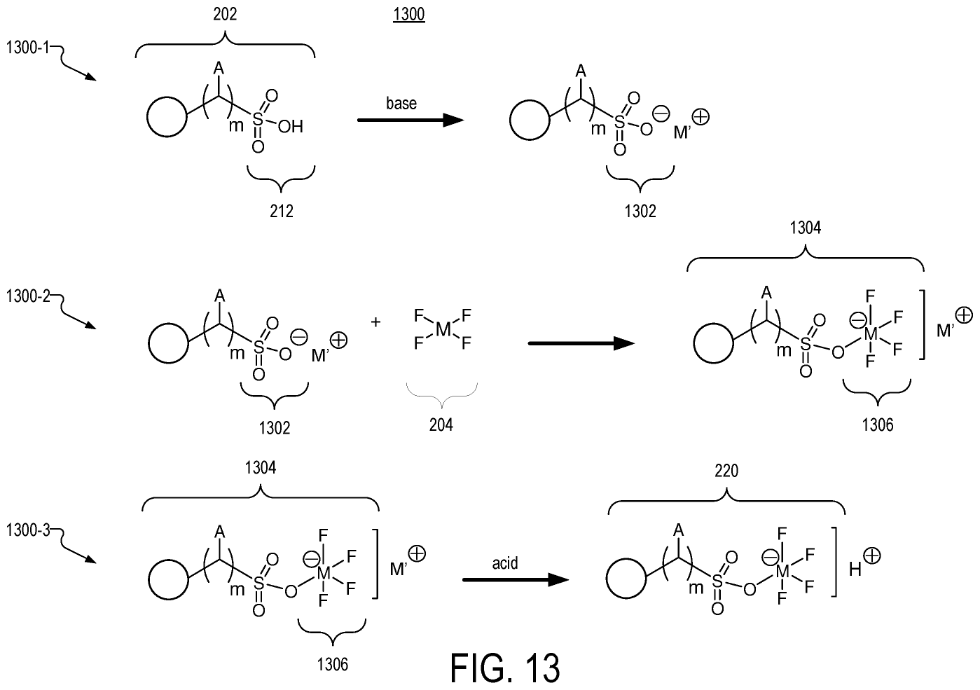

In the reaction schemes described above in the examples of FIGS. 2A to 12B, the direct reaction of an acid group (e.g., a sulfonic acid group, carboxylic acid group, phosphonic acid group, phosphate group) or hydroxyl group with a metal fluoride may not yield complete proton transfer from the acid group or hydroxyl group to the metal fluoride, resulting in an equilibrium mixture and/or incomplete reaction with lesser percentages of intrinsically ionic acidic metal fluoride structures. The strong intermolecular hydrogen bond networks within neighboring acid groups may prevent complete reactions with metal fluorides as these fluorides may not be strong enough to break all these hydrogen bond networks. To address these issues, the reaction schemes of FIGS. 2A to 12B may be carried out in a three step process that involves deprotonation of the acid group, coupling with a metal fluoride, and protonation. This three-step process will now be described with reference to FIG. 13.

FIG. 13 shows another illustrative reaction scheme 1300 for synthesizing metal fluoride-functionalized proton-exchange solid support 220 (shown in reaction scheme 200A and FIG. 2A) from proton-exchange solid support 202 according to a deprotonation-coupling-protonation process. Proton-exchange solid support 202 is as described above, and therefore description of proton-exchange solid support 202 will be omitted. It will be understood that the principles of reaction scheme 1300 may be applied in like manner to other proton-exchange solid supports having any other configuration and/or acid groups or hydroxyl groups to produce a metal fluoride-functionalized proton-exchange solid support, including any of the metal fluoride-functionalized proton-exchange solid supports of reaction schemes 200B-1200B.

In a deprotonation step 1300-1, a base activates the sulfonic acid group 212 of proton-exchange solid support 202. The base deprotonates sulfonic acid group 212 to a negatively charged sulfonate group 1302, which is counterbalanced by a cation of the base (labeled M′), thereby forming a sulfonate salt. The base also breaks open the hydrogen bond networks between neighboring sulfonic acid groups 212, thereby exposing the sulfonate groups 1302 for the next coupling step with metal tetrafluoride 204. Any strong base may be used, such as one or more of a metal hydroxide (e.g., lithium hydroxide, sodium hydroxide, potassium hydroxide, barium hydroxide, zirconium hydroxide, zirconium(IV) hydroxide, iron(II) hydroxide, nickel(II) hydroxide copper(II) hydroxide, zinc hydroxide, aluminum hydroxide, etc.), a metal hydride (e.g., sodium hydride, potassium hydride, lithium hydride, cesium hydride), a metal amide (e.g., lithium diisopropyl amide (LDA)), ammonia, a tetraalkylammonium hydroxide (e.g., tetramethylammonium hydroxide, tetraethylammonium hydroxide, tetrapropylammonium hydroxide, tetrabutylammonium hydroxide, etc.), and a silane base (e.g., monoalkylsilanes (e.g. ethylsilane, propylsilane, isopropylsilane, butylsilane, and/or isobutylsilane), dialkylsilanes, and trialkylsilanes).

In a coupling step 1300-2, the sulfonate salt formed in deprotonation step 1300-1 is coupled with metal tetrafluoride 204. The negatively charged oxygen atom of the sulfonate salt becomes a strong electron-pair donor that covalently bonds with the electron-accepting metal (M) atom of metal tetrafluoride 204, thereby forming an intermediate proton-exchange solid support 1304 having an intrinsically ionic metal fluoride group 1306. The metal (M) atom of metal fluoride group 1306 has a negative formal charge that is counterbalanced by the cation (M′⁺) of the based used in deprotonation step 1300-1.

In a protonation step 1300-3, metal fluoride group 1306 of intermediate proton-exchange solid support 1304 is protonated using an acidic solution to produce metal fluoride-functionalized proton-exchange solid support 220. Any suitable acid may be used, such as, but not limited to, aqueous solutions of hydrochloric acid, sulfuric acid, hydrofluoric acid, trifluoroacetic acid, and a carboxylic acid. Metal fluoride-functionalized proton-exchange solid support 220 is as described above and may be used in any way described herein.

The metal fluorides may also be used with other proton-exchange membranes and ionomers, such as polybenzimidazole (PBI) derivatives. In some examples, an unfunctionalized perfluorinated polymer commonly known as 4F-PBI may be used as a proton-exchange membrane or ionomer. To improve proton conductivity, membranes and ionomers comprising 4F-PBI and/or PBI derivatives may be doped with an acid, such as phosphoric acid, polyphosphoric acid (PPA), phytic acid, or phosphotungstic acid (HPW). However, the acid dopants often leach out of the membranes or ionomers. To prevent this problem, a metal fluoride such as metal trifluoride MF₃ or metal tetrafluoride MF₄ described herein may be combined with the acid dopants, which may react with hydroxyl groups of the acid dopants to cross-link molecules of the acid dopants. The cross-linking of the acid dopants with a metal fluoride may reduce or prevent leaching of the acid dopants from the membranes or ionomers by increasing the size of PPA dopant structures while maintaining or even increasing proton conductivity. The stoichiometric ratio of metal fluoride to the acid dopant may be tailored to obtain the desired degree of cross-linking.

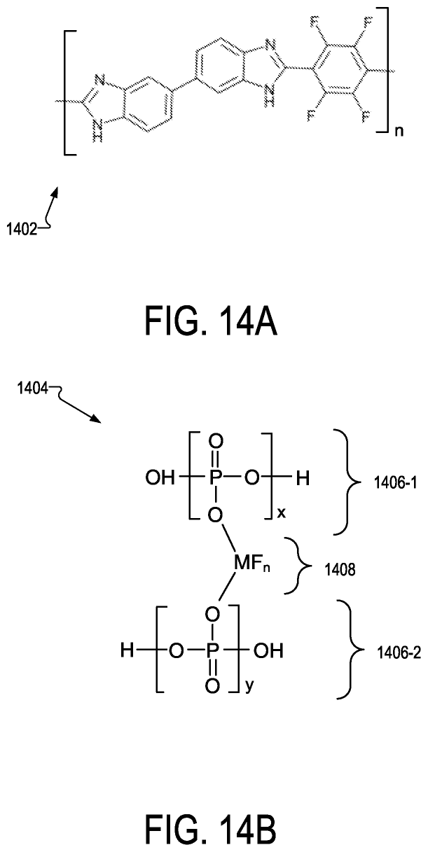

FIG. 14A shows a 4F-PBI polymer 1402 that may be used as a PEM or ionomer, and FIG. 14B shows an illustrative metal fluoride cross-linked PPA dopant network 1404 that may be used as a dopant for a PEM or ionomer formed including polymer 1402. As shown in FIG. 14B, metal fluoride cross-linked PPA dopant network 1404 includes a PPA dopant 1406-1 of chain length x cross-linked with a PPA dopant 1406-2 of chain length y by way of a metal fluoride 1408. Chain lengths x and y are integers ranging from 1 to 30 and may be the same or different. Metal fluoride 1408 has general formula MFₙ as described herein where n is three (3) or four (4). While FIG. 14B shows that the metal atom (M) of metal fluoride 1408 covalently bonds with the oxygen (O) atoms of side-chain hydroxyl groups of PPA dopants 1406-1 and 1406-2, the metal (M) atom may alternatively covalently bond with one or more terminal hydroxyl groups of PPA dopants 1406-1 and/or 1406-2 to cross-link PPA dopants 1406-1 and 1406-2. It will be appreciated that PPA dopants 1406-1 and 1406-2 may be cross-linked by any number of metal fluorides, and any suitable number of PPA dopants may be cross-linked to form a metal-fluoride cross-linked PPA dopant network. Furthermore, any suitable combination of different metal fluorides may be used. As shown in FIG. 14B, the metal (M) atom is covalently bonded to two oxygen (O) atoms and to three (3) or four fluorine (F) atoms. Thus, the metal fluoride 1408 has a negative formal charge, and is intrinsically ionic and serves as a proton transport agent. In some examples, the metal (M) atom of metal fluoride 1408 may covalently bond to three oxygen (O) atoms, whether of the same or different PPA dopants 1406. It will further be appreciated that any other acid dopants besides PPA may be cross-linked by metal fluorides, in accordance with the principles described herein.

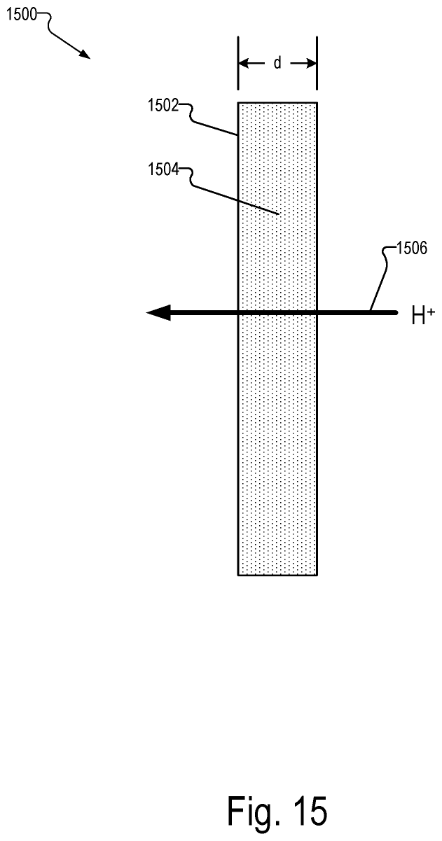

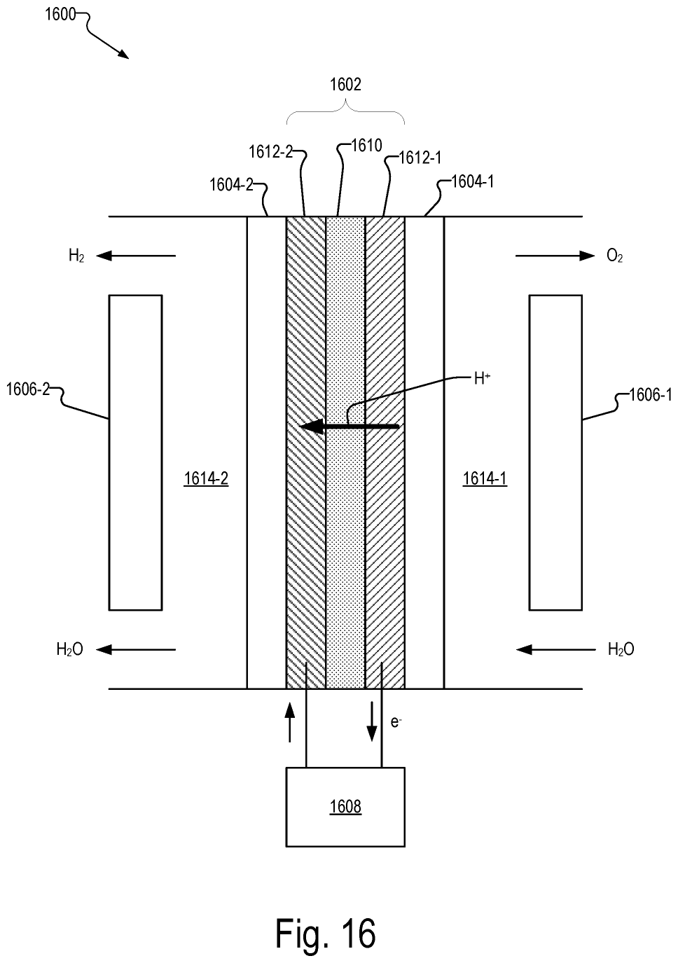

The solid supports, membranes, and ionomers described herein may be used in water electrolysis systems as well as fuel cell systems, including the water electrolysis and fuel cell systems. In some embodiments, the solid supports, membranes, and ionomers described herein may be used as separation membranes in batteries. Illustrative applications will now be described with reference to FIGS. 15-16.

In some examples, metal fluoride-functionalized proton-exchange solid supports may be used in a PEM. FIG. 15 shows an illustrative proton exchange membrane 1500 (PEM 1500). PEM 1500 includes a porous structural framework 1502 and metal fluoride groups 1504 distributed throughout porous structural framework 1502 and bonded to pore surfaces of porous structural framework 1502.

Porous structural framework 1502 may be formed of any suitable solid support or combination of solid supports described herein, including inorganic materials and/or organic materials. Suitable inorganic materials may include amorphous inorganic materials (e.g., glass, fused silica, or ceramics) and/or crystalline inorganic materials (e.g., quartz, single crystal silicon, or alumina). Suitable organic material may include, for example, synthetic and/or natural polymers (e.g., cellulose).

PEM 1500 may have a thickness d ranging from a few microns to hundreds of microns. With the configurations described herein, PEM 1500 may withstand pressure differentials of up to 30 atmospheres and acidic pH gradients across the membrane. PEM 1500 may also be permeable to water and protons, which may be conducted through PEM 1500 as indicated by arrow 1506, but PEM 1500 is generally impermeable to gases including hydrogen and oxygen.

FIG. 16 shows an illustrative proton exchange membrane water electrolysis system 1600 (PEM water electrolysis system 1600) incorporating a metal fluoride-functionalized porous membrane. PEM water electrolysis system 1600 uses electricity to split water into oxygen (O₂) and hydrogen (H₂) via an electrochemical reaction. The configuration of PEM water electrolysis system 1600 is merely illustrative and not limiting, as other suitable configurations as well as other suitable water electrolysis systems may incorporate a metal fluoride-functionalized porous membrane.

As shown in FIG. 16, PEM water electrolysis system 1600 includes a membrane electrode assembly 1602 (MEA 1602), porous transport layers 1604-1 and 1604-2, bipolar plates 1606-1 and 1606-2, and an electrical power supply 1608. PEM water electrolysis system 1600 may also include additional or alternative components not shown in FIG. 16 as may serve a particular implementation.

MEA 1602 includes a PEM 1610 positioned between a first catalyst layer 1612-1 and a second catalyst layer 1612-2. PEM 1610 electrically isolates first catalyst layer 1612-1 from second catalyst layer 1612-2 while providing selective conductivity of cations, such as protons (H⁺), and while being impermeable to gases such as hydrogen and oxygen. PEM 1610 may be implemented by any suitable PEM. For example, PEM 1610 may be implemented by a metal fluoride-functionalized porous membrane (e.g., PEM 1500) comprising a porous structural framework with metal fluoride groups bonded to pore surfaces within the porous structural framework.

First catalyst layer 1612-1 and second catalyst layer 1612-2 are electrically conductive electrodes with embedded electrochemical catalysts (not shown), such as platinum, ruthenium, and/or or cerium(IV) oxide. In some examples, first catalyst layer 1612-1 and second catalyst layer 1612-2 are formed using an ionomer to bind catalyst nanoparticles. The ionomer used to form first catalyst layer 1612-1 and second catalyst layer 1612-2 may include a metal fluoride-functionalized proton-exchange solid support as described herein.

MEA 1602 is placed between porous transport layers 1604-1 and 1604-2, which are in turn placed between bipolar plates 1606-1 and 1606-2 with flow channels 1614-1 and 1614-2 located in between bipolar plates 1606 and porous transport layers 1604.

In MEA 1602, first catalyst layer 1612-1 functions as an anode and second catalyst layer 1612-2 functions as a cathode. When PEM water electrolysis system 1600 is powered by power supply 1608, an oxygen evolution reaction (OER) occurs at anode 1612-1, represented by the following electrochemical half-reaction:

2H₂O→O₂+4H⁺+4e⁻

Protons are conducted from anode 1612-1 to cathode 1612-2 through PEM 1610, and electrons are conducted from anode 1612-1 to cathode 1612-2 by conductive path around PEM 1610. PEM 1610 allows for the transport of protons (H⁺) and water from the anode 1612-1 to the cathode 1612-2 but is impermeable to oxygen and hydrogen. At cathode 1612-2, the protons combine with the electrons in a hydrogen evolution reaction (HER), represented by the following electrochemical half-reaction:

4H⁺+4e⁻+2H₂

The OER and HER are two complementary electrochemical reactions for splitting water by electrolysis, represented by the following overall water electrolysis reaction:

2H₂O→2H₂+O₂

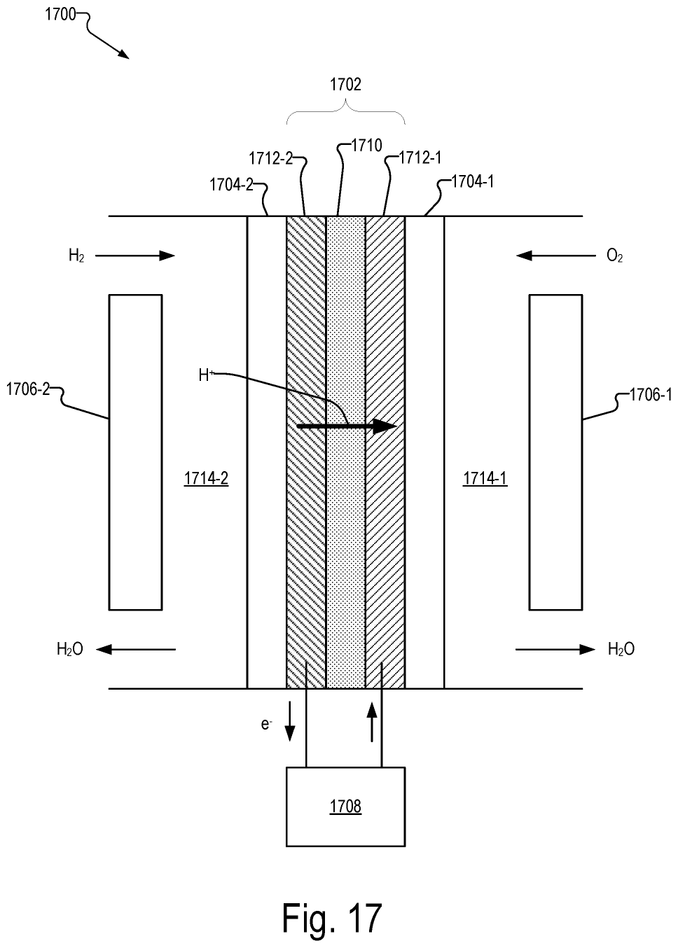

FIG. 17 shows an illustrative proton exchange membrane fuel cell 1700 (PEM fuel cell 1700) including a metal fluoride-functionalized porous membrane. PEM fuel cell 1700 produces electricity as a result of electrochemical reactions. In this example, the electrochemical reactions involve reacting hydrogen gas (H₂) and oxygen gas (O₂) to produce water and electricity. The configuration of PEM fuel cell 1700 is merely illustrative and not limiting, as other suitable configurations as well as other suitable proton exchange membrane fuel cells may incorporate a metal fluoride-functionalized porous membrane.

As shown in FIG. 17, PEM fuel cell 1700 includes a membrane electrode assembly 1702 (MEA 1702), porous transport layers 1704-1 and 1704-2, bipolar plates 1706-1 and 1706-2. An electrical load 1708 may be electrically connected to MEA 1702 and driven by PEM fuel cell 1700. PEM fuel cell 1700 may also include additional or alternative components not shown in FIG. 17 as may serve a particular implementation.

MEA 1702 includes a PEM 1710 positioned between a first catalyst layer 1712-1 and a second catalyst layer 1712-2. PEM 1710 electrically isolates first catalyst layer 1712-1 from second catalyst layer 1712-2 while providing selective conductivity of cations, such as protons (H⁺), and while being impermeable to gases such as hydrogen and oxygen. PEM 1710 may be implemented by any suitable PEM. For example, PEM 1710 may be implemented by a metal fluoride-functionalized porous membrane (e.g., PEM 1500) comprising a porous structural framework with metal fluoride groups bonded to pore surfaces within the porous structural framework.

First catalyst layer 1712-1 and second catalyst layer 1712-2 are electrically conductive electrodes with embedded electrochemical catalysts (not shown). In some examples, first catalyst layer 1712-1 and second catalyst layer 1712-2 are formed using an ionomer to bind catalyst nanoparticles. In some examples, the ionomer used to form first catalyst layer 1712-1 and second catalyst layer 1704-2 includes an ionomer incorporating a metal fluoride-functionalized proton-exchange solid support as described herein.

MEA 1702 is placed between porous transport layers 1704-1 and 1704-2, which are in turn placed between bipolar plates 1706-1 and 1706-2 with flow channels 1714 located in between. In MEA 1702, first catalyst layer 1712-1 functions as a cathode and second catalyst layer 1712-2 functions as an anode. Cathode 1712-1 and anode 1712-2 are electrically connected to load 1708, and electricity generated by PEM fuel cell 1700 drives load 1708.

During operation of PEM fuel cell 1700, hydrogen gas (H₂) flows into the anode side of PEM fuel cell 1700 and oxygen gas (O₂) flows into the cathode side of PEM fuel cell 1700. At anode 1712-2, hydrogen molecules are catalytically split into protons (H⁺) and electrons (e⁻) according to the following hydrogen oxidation reaction (HOR):

2H₂→4H⁺+4e⁻

The protons are conducted from anode 1712-2 to cathode 1712-1 through PEM 1700, and the electrons are conducted from anode 1712-2 to cathode 1712-1 around PEM 1710 through a conductive path and load 1708. At cathode 1712-1, the protons and electrons combine with the oxygen gas according to the following oxygen reduction reaction (ORR):

O₂+4H⁺+4e⁻→2H₂O

Thus, the overall electrochemical reaction for the PEM fuel cell 1700 is:

2H₂+O₂→2H₂O

In the overall reaction, PEM fuel cell 1700 produces water at cathode 1712-1. Water may flow from cathode 1712-1 to anode 1712-2 through PEM 1710 and may be removed through outlets at the cathode side and/or anode side of PEM fuel cell 1700. The overall reaction generates electrons at the anode that drive load 1708.

In the preceding description, various exemplary embodiments have been described with reference to the accompanying drawings. It will, however, be evident that various modifications and changes may be made thereto, and additional embodiments may be implemented, without departing from the scope of the claims that follow. For example, certain features of one embodiment described herein may be combined with or substituted for features of another embodiment described herein. The description and drawings are accordingly to be regarded in an illustrative rather than a restrictive sense.

1. A metal fluoride-functionalized proton-exchange solid support comprising:
a proton-exchange solid support comprising a substituent group including an oxygen (O) atom; and
a metal fluoride group comprising a multivalent metal atom covalently bonded to the oxygen atom included in the substituent group;
wherein the metal atom has a negative formal charge.

2. The metal fluoride-functionalized proton-exchange solid support of claim 1, wherein the metal atom is covalently bonded to three or four fluorine (F) atoms.

3. The metal fluoride-functionalized proton-exchange solid support of claim 1, wherein the metal atom is zirconium (Zr).

4. The metal fluoride-functionalized proton-exchange solid support of claim 1, wherein the metal atom is aluminum (Al), gallium (Ga), or indium (In).

5. The metal fluoride-functionalized proton-exchange solid support of claim 1, wherein the metal atom is silicon (Si), germanium (Ge), or tin (Sn).

6-9. (canceled)

10. The metal fluoride-functionalized proton-exchange solid support of claim 1, wherein:
the proton-exchange solid support further comprises a linker chain linking the substituent group to a solid support; and
the linker chain comprises a C₁ to C₃₀ alkyl chain and optionally has one or more pendant moieties, which may be the same or different for each atom in the linker chain and which may comprise hydrogen, a hydroxyl group, a fluoro group, a chloro group, a dialkylamino group, a cyano group, a carboxylic acid group, a carboxylic amide group, an ester group, an alkyl group, an alkoxy group, or an aryl group.

11-13. (canceled)

14. The metal fluoride-functionalized proton-exchange solid support of claim 1, wherein:
the proton-exchange solid support comprises a porous polymer network; and
the metal fluoride group is located at a pore surface of the porous polymer network.

15-16. (canceled)

17. The metal fluoride-functionalized proton-exchange solid support of claim 1, wherein the proton-exchange solid support comprises a polyvinyl phosphonic acid polymer.

18. (canceled)

19. The metal fluoride-functionalized proton-exchange solid support of claim 1, wherein the proton-exchange solid support comprises a phosphate-functionalized polymer.

20. The metal fluoride-functionalized proton-exchange solid support of claim 19, wherein the phosphate-functionalized polymer comprises a polybenzimidazole (PBI) polymer doped with polyphosphoric acid.

21. The metal fluoride-functionalized proton-exchange solid support of claim 20, wherein chains of the polyphosphoric acid are cross-linked with a metal fluoride.

22-24. (canceled)

25. A metal fluoride-functionalized proton-exchange solid support having general formula (Ia) or (Ib):
[SS]—Xₘ-MFₙ (Ia)
[SS]—R_{q}—Xₘ-MFₙ (Ib)
wherein:
[SS] represents a solid support;
each X independently represents a substituent group having any one of formula (IIa), (IIb), (IIc), (IId), (IIe), or (IIf): 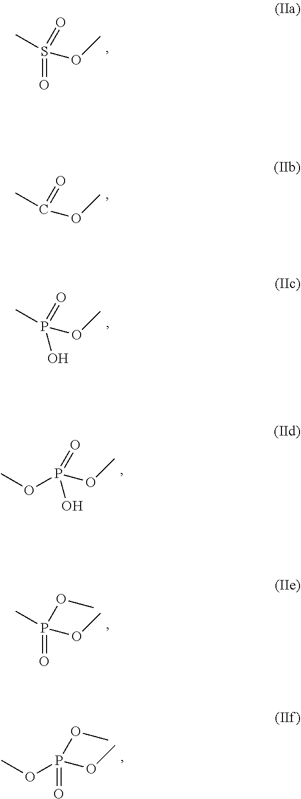
m is one (1), two (2), or three (3);
M is a multivalent metal atom covalently bonded to one or more oxygen (O) atoms in one or more substituent groups X and has a negative formal charge;
n is three (3) or four (4);
the sum of m and n is four (4), five (5), or six (6);
each R independently represents a C₁ to C₃₀ alkyl linker chain that links a substituent group X with solid support [SS] and optionally has one or more pendant moieties, which may be the same or different for each atom in the linker chain R and which may comprise hydrogen, a hydroxyl group, a fluoro group, a chloro group, a dialkylamino group, a cyano group, a carboxylic acid group, a carboxylic amide group, a carboxylic ester group, an alkyl group, an alkoxy group, and an aryl group; and
q is an integer equal to or less than m.

26. The metal fluoride-functionalized proton-exchange solid support of claim 25, wherein the metal (M) atom is selected from Group 4, Group 13, or Group 14 of the periodic table.

27-28. (canceled)

29. The metal fluoride-functionalized proton-exchange solid support of claim 25, wherein the solid support comprises an ionomer.

30. (canceled)

31. The metal fluoride-functionalized proton-exchange solid support of claim 25, wherein:
[SS]—Xₘ or [SS]—R—Xₘ of general formula (Ia) or (Ib) forms a porous polymer network with one or more pendant substituent groups X; and
MFₙ is located at pore surfaces of the porous polymer network.

32. The metal fluoride-functionalized proton-exchange solid support of claim 25, wherein:
m is one (1) so that formula (Ia) or (Ib) is represented by the following formula (Ia1) or (Ib1): 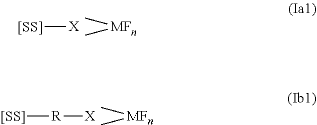
and n is three (3) or four (4).

33. The metal fluoride-functionalized proton-exchange solid support of claim 25, wherein:
m is two (2) so that formula (Ia) or (Ib) is represented by the following formula (Ia2) or (Ib2): 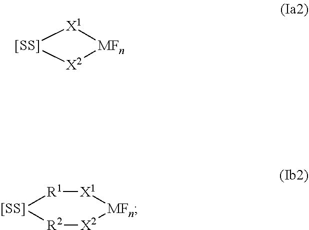
X¹ and X² each represent substituent group X and may be the same or different;
n is three (3) or four (4);
R¹ and R² each represent linker chain R and may be the same or different; and
the multivalent metal (M) atom is covalently bonded to an oxygen atom (O) included in each of substituent group X¹ and substituent group X².

34. The metal fluoride-functionalized proton-exchange solid support of claim 25, wherein:
m is 3 so that formula (Ia) or (Ib) has the following formula (Ia3) or (Ib3): 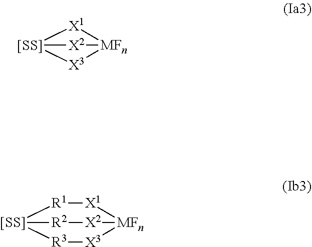
X¹, X², and X³ each represent substituent group X and may be the same or different;
n is three (3);
R¹, R², and R³ each represent linker chain R and may be the same or different; and
the multivalent metal (M) atom is covalently bonded to an oxygen atom (O) included in each of substituent group X¹ and substituent group X² and substituent group X³.

35. The metal fluoride-functionalized proton-exchange solid support of claim 25, wherein:
m is 2 so that formula (Ia) or (Ib) has the following formula (Ia4) or (Ib4): 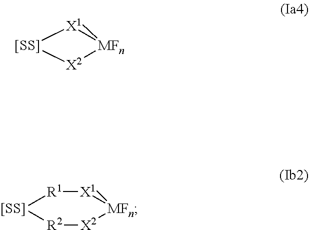
X¹ represents a substituent group X having two oxygen (O) atoms;
X² represents a substituent group X having an oxygen (O) atom and may be the same as or different from X¹;
n is three (3);
R¹ and R² each represent linker chain R and may be the same or different; and
the multivalent metal (M) atom is covalently bonded to the two oxygen atoms included in substituent group X¹ and is covalently bonded to the oxygen atom in substituent group X².

36-51. (canceled)

52. A solid electrolyte comprising:
a proton-exchange solid support comprising an oxygen atom; and
a metal fluoride group comprising a metal atom covalently bonded to the oxygen atom and forming a tetravalent, pentavalent, or hexavalent structure;
wherein the metal atom has a formal negative charge.

53. (canceled)
